(19) United States
(12) Patent Application Publication
(10) Pub. No.: US 2024/0031852 A1
(43) Pub. Date: Jan. 25, 2024

(54) Service Processing Method and Apparatus, Terminal Device, and Chip

(71) Applicant: Huawei Technologies Co., Ltd., Shenzhen (CN)

(72) Inventors: Jian Jiang, Shanghai (CN); Bo Yu, Beijing (CN); Qiang Yu, Beijing (CN)

(21) Appl. No.: 18/256,451

(22) PCT Filed: Dec. 8, 2021
(86) PCT No.: PCT/CN2021/136518

§ 371 Date: Jun. 8, 2023

(30) Foreign Application Priority Data
Dec. 9, 2020 (CN) 202011449833.8

(51) Int. Cl. H04W 24/10; H04B 7/0413; H04B 7/08

(52) U.S. Cl. CPC H04W 24/10; H04B 7/0413; H04B 7/0802; H04W 88/06

(57) ABSTRACT

This application provides a service processing method and apparatus, a terminal device, and a chip, and relates to the field of communication technologies. When the terminal device carries a primary card and a secondary card, the secondary card uses one or more antennas by default to process an uplink/downlink transmission service. When the primary card is triggered to perform neighboring cell measurement (e.g., inter-frequency inter-RAT measurement), and a measurement band is the same as an operating band of the secondary card, the primary card may select an antenna different from an antenna used by the secondary card to perform neighboring cell measurement.

### CROSS-REFERENCE TO RELATED APPLICATIONS

This application is a national stage of International Application No. PCT/CN2021/136518, filed on Dec. 8, 2021, which claims priority to Chinese Patent Application No. 202011449833.8, filed on Dec. 9, 2020, which is hereby incorporated by reference in its entirety.

### TECHNICAL FIELD

This application relates to the field of communication technologies, and in particular, to a service processing method and apparatus, a terminal device, and a chip.

### BACKGROUND

A dual-SIM terminal device usually includes a primary card and a secondary card, and the primary card and the secondary card may process services in parallel. Due to a limitation of hardware design, in the dual-SIM terminal device, the primary card and the secondary card need to share a front-end radio frequency antenna. When the primary card and the secondary card process services in parallel, the primary card and the secondary card may share one or some antennas of the terminal device to transmit signals. In this case, signal crosstalk may occur between a service signal of the primary card and a service signal of the secondary card, causing a conflict of sharing an antenna.

### SUMMARY

This application provides a service processing method and apparatus, a terminal device, and a chip, to resolve a problem in the conventional technology that signal crosstalk is caused by a conflict when two cards in a terminal device share an antenna to process services in parallel.

To achieve the foregoing objective, this application uses the following technical solutions.

According to a first aspect, this application provides a service processing method, applied to a terminal device, where the terminal device includes M antennas, and the method includes: When the terminal device carries a first subscriber identity module SIM card and a second SIM card, the second SIM card processes an uplink/downlink transmission service by using N antennas, where the N antennas are one or more antennas of the M antennas; and when the terminal device meets a preset condition, the first SIM card processes a neighboring cell measurement service by using at least one antenna of M-N antennas, where an operating band of the neighboring cell measurement service is the same as an operating band of the uplink/downlink transmission service.

According to the foregoing solution, when the terminal device carries the first SIM card and the second SIM card, the second SIM card processes the uplink/downlink transmission service by using one or more antennas by default. When the first SIM card is triggered to perform neighboring cell measurement (namely, inter-frequency inter-RAT measurement), and a measurement frequency band is the same as an operating band of the second SIM card, the first SIM card may select an antenna different from an antenna used by the second SIM card to perform neighboring cell measurement. Because signal crosstalk occurs in signals with a same frequency band in an antenna receive channel, when the measurement frequency band of the first SIM card is the same as the operating band of the second SIM card, it can be determined that a conflict occurs when the first SIM card and the second SIM card share an antenna. Therefore, the first SIM card may perform neighboring cell measurement by using an antenna different from an antenna occupied by the second SIM card, to ensure that the two cards can process services in parallel and do not affect each other, thereby resolving a current problem that signal crosstalk is caused when two cards in the terminal device share an antenna to process services in parallel.

In some embodiments, the M antennas include a primary and diversity antenna and a multiple-input multiple-output MIMO primary and diversity antenna, where the primary and diversity antenna includes a primary antenna and a diversity antenna, and the MIMO primary and diversity antenna includes a MIMO primary antenna and a MIMO diversity antenna.

In some embodiments, before the first SIM card processes the neighboring cell measurement service by using the at least one antenna of the M-N antennas, the method further includes: determining, based on the operating band of the neighboring cell measurement service and the operating band of the uplink/downlink transmission service, that an antenna used by the first SIM card to process the neighboring cell measurement service is the at least one antenna of the M-N antennas.

The M-N antennas refer to an antenna other than the N antennas in the M antennas. For example, when the M antennas include the primary and diversity antenna and the MIMO primary and diversity antenna, and the N antennas occupied by the secondary card are the primary and diversity antenna, the M-N antennas allocated by the terminal device to the primary card may be the MIMO primary and diversity antenna. For another example, when the M antennas include the primary and diversity antenna and the MIMO primary and diversity antenna, and the N antenna occupied by the secondary card is the primary antenna, the M-N antennas allocated by the terminal device to the primary card may be the MIMO primary and diversity antenna.

In some embodiments, the preset condition may include at least one of the following conditions: signal quality of a serving cell of the first SIM card is lower than a preset signal quality threshold; and the terminal device receives a measurement configuration message delivered by a network device, where the measurement configuration message indicates to measure signal quality of a neighboring cell of the serving cell of the first SIM card.

In some embodiments, that the second SIM card processes the uplink/downlink transmission service by using the N antennas includes:

When the first SIM card is in a standby state and the second SIM card is in a connected state, the second SIM card processes the uplink/downlink transmission service by using the N antennas; or when the first SIM card is in a connected state and the second SIM card is in a connected state, the second SIM card processes the uplink/downlink transmission service by using the N antennas.

It may be understood that when the secondary card is in the connected state, the secondary card usually receives or sends uplink and downlink data and processes the uplink/downlink transmission service by using one or some preset antennas (namely, the foregoing N antennas) by default.

In some embodiments, the method further includes: When the second SIM card is in a standby state and the terminal device meets the preset condition, the first SIM card processes the neighboring cell measurement service by using the N antennas.

It should be noted that the first SIM card usually performs neighboring cell measurement by using the N antennas, and the second SIM card usually receives or sends uplink and downlink data also by using the N antennas. When the second SIM card uses the N antennas, if the first SIM card is triggered to perform neighboring cell measurement, and a neighboring cell measurement frequency band is the same as the operating band of the second SIM card, the first SIM card cannot share the N antennas with the second SIM card in this case. Therefore, the first SIM card may select an antenna different from the N antennas to perform neighboring cell measurement, to avoid a possible conflict caused by sharing an antenna by the services of the two cards.

In some embodiments, when M is 4 and N is 1, that the first SIM card processes the neighboring cell measurement service by using the at least one antenna of the M-N antennas includes:

When the second SIM card uses the primary antenna, the first SIM card receives a signal of the neighboring cell measurement service by using the MIMO primary and diversity antenna; or when the second SIM card uses the diversity antenna, the first SIM card receives a signal of the neighboring cell measurement service by using the MIMO primary and diversity antenna; or when the second SIM card uses the MIMO primary antenna, the first SIM card receives a signal of the neighboring cell measurement service by using the primary and diversity antenna; or when the second SIM card uses the MIMO diversity antenna, the first SIM card receives a signal of the neighboring cell measurement service by using the primary and diversity antenna.

It may be understood that, when the second SIM card uses one of the four antennas, the first SIM card may use two of the other three antennas to perform neighboring cell measurement. In this way, it can be ensured that the two SIM cards can process services in parallel and do not affect each other.

In some embodiments, when M is 4 and N is 2, that the first SIM card processes the neighboring cell measurement service by using the at least one antenna of the M-N antennas includes:

When the second SIM card uses the primary and diversity antenna, the first SIM card receives a signal of the neighboring cell measurement service by using the MIMO primary and diversity antenna; or when the second SIM card uses the MIMO primary and diversity antenna, the first SIM card receives a signal of the neighboring cell measurement service by using the primary and diversity antenna; or when the second SIM card uses the primary antenna and the MIMO primary antenna, the first SIM card receives a signal of the neighboring cell measurement service by using the diversity antenna and the MIMO diversity antenna; or when the second SIM card uses the primary antenna and the MIMO diversity antenna, the first SIM card receives a signal of the neighboring cell measurement service by using the diversity antenna and the MIMO primary antenna; or when the second SIM card uses the diversity antenna and the MIMO primary antenna, the first SIM card receives a signal of the neighboring cell measurement service by using the primary antenna and the MIMO diversity antenna; or when the second SIM card uses the diversity antenna and the MIMO diversity antenna, the first SIM card receives a signal of the neighboring cell measurement service by using the primary antenna and the MIMO primary antenna.

It may be understood that, when the second SIM card uses two of the four antennas, the first SIM card may use the other two antennas to perform neighboring cell measurement. In this way, it can be ensured that the two cards can process services in parallel and do not affect each other.

In some embodiments, when M is 4 and N is 3, that the first SIM card processes the neighboring cell measurement service by using the at least one antenna of the M-N antennas includes:

When the second SIM card uses the primary and diversity antenna and the MIMO primary antenna, the first SIM card receives a signal of the neighboring cell measurement service by using the MIMO diversity antenna; or when the second SIM card uses the primary and diversity antenna and the MIMO diversity antenna, the first SIM card receives a signal of the neighboring cell measurement service by using the MIMO primary antenna; or when the second SIM card uses the primary antenna and the MIMO primary and diversity antenna, the first SIM card receives a signal of the neighboring cell measurement service by using the primary antenna; or when the second SIM card uses the diversity antenna and the MIMO primary and diversity antenna, the first SIM card receives a signal of the neighboring cell measurement service by using the primary antenna.

It may be understood that, when the second SIM card uses three of the four antennas, the first SIM card may use the other antenna to perform neighboring cell measurement. In this way, it can be ensured that the two SIM cards can process services in parallel and do not affect each other.

In some embodiments, the method further includes: If the second SIM card processes the uplink/downlink transmission service by using the N antennas, when the terminal device meets the preset condition, the first SIM card processes the neighboring cell measurement service by using the N antennas, where the operating band of the neighboring cell measurement service is different from the operating band of the uplink/downlink transmission service.

Because signal crosstalk does not occur in signals with different frequency bands in an antenna receive channel, when the measurement frequency band of the first SIM card is different from the operating band of the second SIM card, it can be determined that no conflict occurs if the first SIM card and the second SIM card share an antenna. Therefore, the first SIM card may perform neighboring cell measurement by using an antenna the same as an antenna occupied by the second SIM card.

In some embodiments, the method further includes: If the second SIM card processes the uplink/downlink transmission service by using the M antennas, when the terminal device meets the preset condition, the first SIM card and the second SIM card process the services by using the M antennas in a time-division manner, where the operating band of the neighboring cell measurement service of the first SIM card is the same as the operating band of the uplink/downlink transmission service of the second SIM card. A measurement proportion corresponding to the neighboring cell measurement service is less than a preset threshold, and the measurement proportion is a ratio of measurement duration corresponding to the neighboring cell measurement service to a measurement cycle corresponding to the neighboring cell measurement service.

Because signal crosstalk occurs in signals with a same frequency band in an antenna receive channel, when the measurement frequency band of the first SIM card is the same as the operating band of the second SIM card, it may be determined that a conflict occurs if the first SIM card and the second SIM card share an antenna. When all antennas of the terminal device are occupied by the second SIM card, the first SIM card and the second SIM card use all of the antennas to process services in the time-division manner. For example, when the first SIM card uses all of the antennas to perform neighboring cell measurement, a service of the second SIM card is suppressed, and after the neighboring cell measurement ends, the second SIM card may use all of the antennas to process the service. In this way, it can be ensured that both of the two cards can use the antennas to process services, and the two cards do not affect each other.

It may be understood that a smaller measurement proportion of neighboring cell measurement indicates less impact of neighboring cell measurement by the first SIM card on the uplink/downlink transmission service of the second SIM card. Therefore, in this embodiment of this application, the measurement proportion may be set to be less than the preset threshold, so that suppression duration of the service of the second SIM card can be reduced. For example, a manner of reducing the measurement proportion may be implemented by shortening measurement duration and/or extending a measurement cycle (namely, a time gap between every two times of measurement).

In some embodiments, the first SIM card may be a primary card, and the second SIM card may be a secondary card.

According to a second aspect, this application further provides a service processing apparatus, and the apparatus includes units configured to perform the method in the first aspect. The apparatus may correspondingly perform the method described in the first aspect. For related descriptions of the units in the apparatus, refer to the descriptions of the first aspect. For brevity, details are not described herein again.

According to a third aspect, this application provides a terminal device, where the terminal device includes a processor, the processor is coupled to a memory, the memory is configured to store a computer program or instructions, and the processor is configured to read and execute the computer program or the instructions stored in the memory to implement the method in the first aspect.

For example, the processor is configured to execute the computer program or the instructions stored in the memory, so that the terminal device performs the method in the first aspect.

According to a fourth aspect, this application provides a computer-readable storage medium. The computer-readable storage medium stores a computer program (also referred to as instructions or code) used to implement the method in the first aspect.

For example, when the computer program is executed by a computer, the computer is enabled to perform the method in the first aspect.

According to a fifth aspect, this application provides a chip, including a processor. The processor is configured to read and execute a computer program stored in a memory, to perform the method in the first aspect or any one of the possible implementations of the first aspect.

Optionally, the chip further includes a memory, and the memory is connected to the processor by using a circuit or a wire.

According to a sixth aspect, this application provides a chip system, applied to a terminal device. The chip system includes at least one memory, at least one processor, and a communication interface. The communication interface and the at least one processor are interconnected by using a wire. The at least one memory stores a computer program (also referred to as instructions or code). When the computer program is executed by the processor, the method in the first aspect is implemented.

According to a seventh aspect, this application provides a computer program product. The computer program product includes a computer program (also referred to as instructions or code), and when the computer program is executed by a computer, the computer is enabled to implement the method in the first aspect.

It may be understood that for beneficial effects of the second aspect to the seventh aspect, refer to related descriptions in the first aspect. Details are not described herein again.

### BRIEF DESCRIPTION OF DRAWINGS

FIG. 1 is a schematic diagram of currently sharing an antenna when a primary card processes a neighboring cell measurement service and a secondary card processes a service;

FIG. 2 is a first schematic flowchart of a service processing method according to an embodiment of this application;

FIG. 3 is a second schematic flowchart of a service processing method according to an embodiment of this application;

FIG. 4 is a schematic diagram of determining, based on an operating band, whether a shared antenna conflicts according to an embodiment of this application;

FIG. 5 is a third schematic flowchart of a service processing method according to an embodiment of this application;

FIG. 6 is a first schematic diagram of application of a service processing method according to an embodiment of this application;

FIG. 7 is a second schematic diagram of application of a service processing method according to an embodiment of this application;

FIG. 8 is a third schematic diagram of application of a service processing method according to an embodiment of this application;

FIG. 9 is a fourth schematic diagram of application of a service processing method according to an embodiment of this application;

FIG. 10 is a first schematic diagram of a structure of a service processing apparatus according to an embodiment of this application;

FIG. 11 is a second schematic diagram of a structure of a service processing apparatus according to an embodiment of this application; and

FIG. 12 is a schematic diagram of a structure of a terminal device according to an embodiment of this application.

### DESCRIPTION OF EMBODIMENTS

To make the objectives, technical solutions, and advantages of embodiments of this application clearer, the following clearly and completely describes the technical solutions in embodiments of this application with reference to accompanying drawings in embodiments of this application. It is clear that the described embodiments are some rather than all of embodiments of this application. All other embodiments obtained by a person of ordinary skill in the art based on embodiments of this application without creative efforts shall fall within the protection scope of this application.

Technical solutions in embodiments of this application may be applied to various communication systems, for example, a global system for mobile communications (global system for mobile communications, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an LTE frequency division duplex (frequency division duplex, FDD) system, an LTE time division duplex (time division duplex, TDD) system, a universal mobile telecommunications system (universal mobile telecommunications system, UMTS), a worldwide interoperability for microwave access (worldwide interoperability for microwave access, WiMAX) communication system, and a future 5th generation (5th generation, 5G) system or a new radio (new radio, NR) system.

The terminal device in embodiments of this application may include a device that provides a voice and/or data connectivity for a user. Specifically, the terminal device includes a device that provides a voice for a user, or includes a device that provides data connectivity for a user, or includes a device that provides a voice and data connectivity for a user. For example, the terminal device may include a handheld device having a wireless connection function, or a processing device connected to a wireless modem. The terminal device may communicate with a core network device by using a radio access network (radio access network, RAN) device, and exchange a voice or data with the RAN, or exchange a voice and data with the RAN. The terminal device may include user equipment (user equipment, UE), a wireless terminal device, a mobile terminal device, a device-to-device (device-to-device, D2D) terminal device, a vehicle to everything (vehicle to everything, V2X) terminal device, a machine-to-machine/machine type communications (machine-to-machine/machine-type communications, M2M/MTC) terminal device, an internet of things (internet of things, IoT) terminal device, a subscriber unit (subscriber unit), a subscriber station (subscriber station), a mobile station (mobile station), a remote station (remote station), an access point (access point, AP), a remote terminal (remote terminal), an access terminal (access terminal), a user terminal (user terminal), a user agent (user agent), a user device (user device), or the like. For example, the terminal device may include a mobile phone (or referred to as a “cellular” phone), a computer with a mobile terminal device, or a portable, pocket-sized, handheld, or computer built-in mobile apparatus, for example, a personal communication service (personal communication service, PCS) phone, a cordless phone, a session initiation protocol (session initiation protocol, SIP) phone, a wireless local loop (wireless local loop, WLL) station, a personal digital assistant (personal digital assistant, PDA), a handheld device with a wireless communication function, a computing device or another processing device connected to a wireless modem, a vehicle-mounted device, a wearable device, a terminal device in a future 5G network, or a terminal device in a future evolved public land mobile network (public land mobile network, PLMN). This is not limited in embodiments of this application.

In embodiments of this application, an apparatus configured to implement a function of the terminal device may be a terminal device, or may be an apparatus, for example, a chip system, that can support the terminal device in implementing the function. The apparatus may be mounted in the terminal device. In this embodiment of this application, the chip system may include a chip, or may include a chip and another discrete component. In the technical solutions provided in embodiments of this application, the technical solutions provided in embodiments of this application are described by using an example in which the apparatus configured to implement the function of the terminal is the terminal device.

For ease of understanding embodiments of this application, the following describes a part of terms in embodiments of this application, to help a person skilled in the art have a better understanding.
(1) Dual-SIM terminal device: Two subscriber identity module (subscriber identity module, SIM) cards are installed in the dual-SIM terminal device. One SIM card may be considered as a primary SIM card, and the other SIM card may be considered as a secondary SIM card. The dual-SIM terminal device may be a dual-SIM dual-standby (dual-SIM dual-standby, DSDS) terminal device or a dual-SIM dual-active device. For ease of description, a SIM card and an evolution thereof are collectively referred to as a SIM card in embodiments of this application. For example, the SIM card may be an identity card of a global system for mobile communications (global system for mobile communications, GSM) digital mobile phone user, and is configured to store an identity code and a key of the user, and support authentication of the user by the GSM system. For another example, the SIM card may also be a universal subscriber identity module (universal subscriber identity module, USIM) card, or may be referred to as an upgrade SIM card, or may be an eSIM card in some embodiments.

The SIM card may further include subscriber information, a virtual SIM card, or a subscriber identity (such as an international mobile subscriber identity (international mobile subscriber identity, IMSI) or a temporary mobile subscriber identity (temporary mobile subscriber identity, TMSI)). From a perspective of a network side, different SIM cards logically correspond to different communication entities served by the network side. For example, a terminal device supporting two SIM cards may be considered as two communication entities or two user equipments for the network side. Therefore, the two SIM cards can process different services independently. For example, the terminal device includes a primary card and a secondary card. The primary card may be responsible for processing an inter-frequency inter-RAT measurement service and a primary card-based uplink/downlink transmission service, and the secondary card may be responsible for processing a secondary card-based uplink/downlink transmission service.

It should be noted that two SIM cards in one terminal device may belong to a same operator or may belong to different operators. This is not limited in embodiments of this application. In addition, in actual application, one terminal device may support more than two SIM cards, which may be specifically determined based on an actual use requirement. This is not limited in embodiments of this application.
(2) Inter-frequency inter-RAT measurement: To ensure communication quality of a terminal device during movement, the terminal device schedules inter-frequency measurement and/or inter-RAT measurement based on configuration information sent by a network device, which is referred to as inter-frequency inter-RAT measurement for short. When a measurement result meets a condition, an inter-frequency or inter-RAT handover may be performed. Inter-frequency measurement refers to measurement of signal quality of an intra-RAT neighboring cell when a carrier frequency of a serving cell is different from a carrier frequency of the intra-RAT neighboring cell. Inter-RAT measurement refers to measurement of signal quality of an inter-RAT neighboring cell when a carrier frequency of a serving cell is different from a carrier frequency of the inter-RAT neighboring cell. It should be noted that, because inter-frequency inter-RAT measurement measures signal quality of a neighboring cell, it may also be referred to as neighboring cell measurement. The terminal device usually performs inter-frequency inter-RAT measurement within a measurement gap (GAP).

The following describes how inter-frequency inter-RAT measurement is triggered and a measurement process after the triggering. A terminal device measures signal quality of a serving cell frequency, and reports a measurement result to a network device. The network device compares the signal quality with a preset threshold. If the signal quality is lower than the preset threshold, the network device sends a reconfiguration message (where an A2 event is configured, indicating that the signal quality of the serving cell is lower than the preset threshold) to the terminal device, to trigger the terminal device to perform inter-frequency inter-RAT measurement.

Further, after inter-frequency inter-RAT measurement is triggered, the terminal device measures related indicators such as received signal strength indication (received signal strength indication, RSSI), reference signal receiving power (reference signal receiving power, RSRP), and reference signal receiving quality (reference signal receiving quality, RSRQ) of an intra-RAT neighboring cell of the current serving cell (that is, inter-frequency measurement), and reports a measurement result to the network device, and further measures signal quality of an inter-RAT cell (that is, inter-RAT measurement) and reports a measurement result to the network device. The network device determines, based on the measurement result, whether a measured target cell meets a preset condition, for example, signal quality of the target cell is better than signal quality of the serving cell, to perform an operation such as cell handover or secondary cell addition, and further provide a service for the terminal device.

It should be further noted that, when the terminal device performs inter-frequency inter-RAT measurement, due to a hardware limitation, signals of only two receive antennas are usually used. In actual application, a primary and diversity antenna is selected by default.
(3) Primary and diversity antenna: A primary and diversity antenna includes a primary antenna and a diversity antenna. The primary antenna is responsible for transmitting and receiving a radio frequency (radio frequency, RF) signal, and the diversity antenna only receives a signal and does not send a signal. A terminal device having a primary and diversity antenna has a capability of receiving a signal through two antenna channels (2R for short). A primary and diversity antenna may be disposed in a terminal device. Certainly, to improve transmit and receive performance, another one or more primary and diversity antennas may be further disposed, which may be referred to as a multiple-input multiple-output (multiple-input multiple-output, MIMO) primary and diversity antenna.

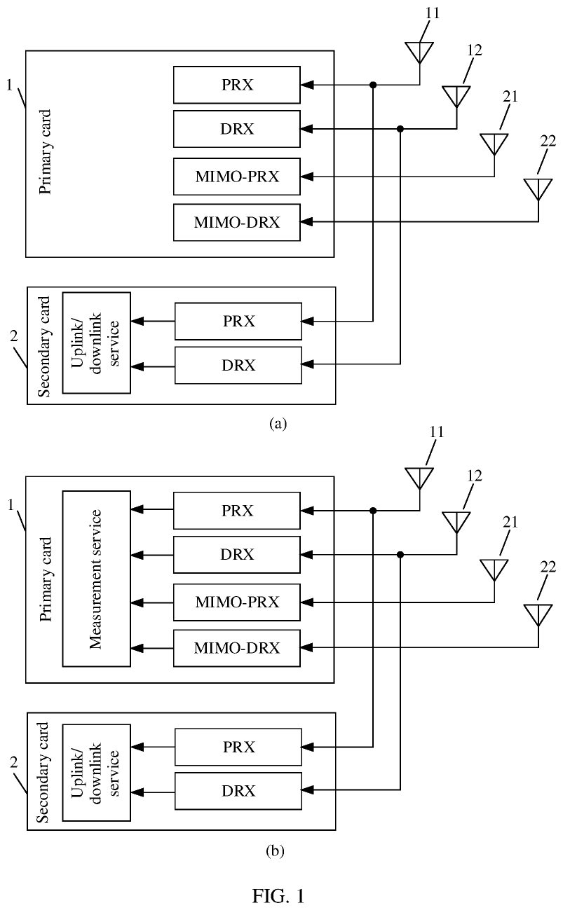

For example, as shown in FIG. 1, a terminal device includes four antennas: an antenna 11, an antenna 12, an antenna 21, and an antenna 22. The antenna 11 and the antenna 12 may be a primary and diversity antenna. The antenna 11 may be a primary antenna, and the antenna 12 may be a diversity antenna. The antenna 21 and the antenna 22 are another primary and diversity antenna. For ease of differentiation, the antenna 21 and the antenna 22 are referred to as a MIMO primary and diversity antenna, the antenna 21 may be a MIMO primary antenna, and the antenna 22 may be a MIMO diversity antenna.

In a dual-SIM terminal device, a primary card and a secondary card can perform services in parallel. Due to a limitation of hardware design, in the dual-SIM terminal device, the primary card and the secondary card share a front-end radio frequency antenna. Usually, both the primary and diversity antenna and the MIMO primary and diversity antenna support a service operating band of the primary card. When a service arrives, the secondary card may preempt one or more antennas of the primary and diversity antenna for signal transmission. For example, when both the primary card and the secondary card work in Sub 3G, for some terminal devices, the secondary card occupies a primary and diversity antenna when receiving a signal; for some terminal devices, the secondary card occupies a diversity antenna when receiving a signal; and for some terminal devices, the secondary card further occupies a primary antenna when sending a signal. The following uses an example in which the secondary card occupies a primary and diversity antenna for description.

It should be noted that when signal quality of a serving cell in which the terminal device is currently located does not meet a condition, a network device indicates the terminal device to perform inter-frequency inter-RAT measurement. The inter-frequency inter-RAT measurement service is usually processed by the primary card of the terminal device, and the primary card usually selects a primary and diversity antenna by default to receive an inter-frequency inter-RAT measurement signal. In addition, when processing an uplink/downlink service, the secondary card also selects the primary and diversity antenna by default to receive uplink and downlink data signals. For example, as shown in (a) in FIG. 1, a secondary card 2 is receiving uplink and downlink service signals by using a primary and diversity antenna. In this case, a primary card 1 does not process an inter-frequency inter-RAT measurement service. In this case, there is no conflict problem. Further, as shown in (b) in FIG. 1, when the secondary card 2 processes a service, once the primary card needs to process the inter-frequency inter-RAT measurement service, both the primary card 1 and the secondary card 2 occupy the primary and diversity antenna. In this case, a conflict may occur.

As described above, in inter-frequency inter-RAT measurement, the primary card uses the primary and diversity antenna by default to receive a signal. In addition, the secondary card shares the primary and diversity antenna with the primary card to transmit a signal. In this case, the measurement service of the primary card and a service of the secondary card use the same antenna. As a result, a measurement result may be unreliable (for example, a measurement result of the primary card may not accurately reflect quality of a service transmitted and received at the frequency), or a device such as the antenna may be damaged.

To resolve the foregoing problem of the conflict between the primary and diversity antenna used during inter-frequency inter-RAT measurement and the antenna of the secondary card, in a possible embodiment, receiving and sending of the secondary card are suppressed in an inter-frequency inter-RAT measurement process of the primary card, in other words, in a time period of inter-frequency inter-RAT measurement by the primary card, the secondary card does not use the primary and diversity antenna to perform receiving and sending, that is, a service of the secondary card is suppressed, so that the antenna is reserved for only the primary card to use. However, each measurement service of the primary card causes interruption of an uplink/downlink service of the secondary card, and the service of the secondary card is frequently interrupted. As a result, a data transmission rate of the secondary card decreases, and voice quality deteriorates.

In view of this, an embodiment of this application provides a service processing method, to resolve a problem facing a dual-SIM terminal device of a conflict between an antenna used in inter-frequency inter-RAT measurement by a primary card and an antenna used in a service sending and receiving scenario of a secondary card, and avoid a problem that a service of the secondary card is frequently interrupted during inter-frequency inter-RAT measurement scheduling of the primary card in the conventional technology.

The following describes in detail features and example embodiments of each aspect of this application. In the following detailed description, many specific details are provided to provide a comprehensive understanding of this application. However, it is clear for a person skilled in the art that this application may be implemented without some of the specific details. The following description of embodiments is merely intended to provide a better understanding of this application by showing an example of this application. This application is not limited to any specific configuration and algorithm proposed below, but covers any modification, replacement, and improvement of elements, components, and algorithms without departing from the spirit of this application. In the following accompanying drawings and descriptions, well-known structures and technologies are omitted, in order not to unnecessarily obscure this application. It should be noted that embodiments in this application and the features in embodiments may be mutually combined in the case of no conflict. This application is described in detail in the following with reference to the accompanying drawings by using embodiments.

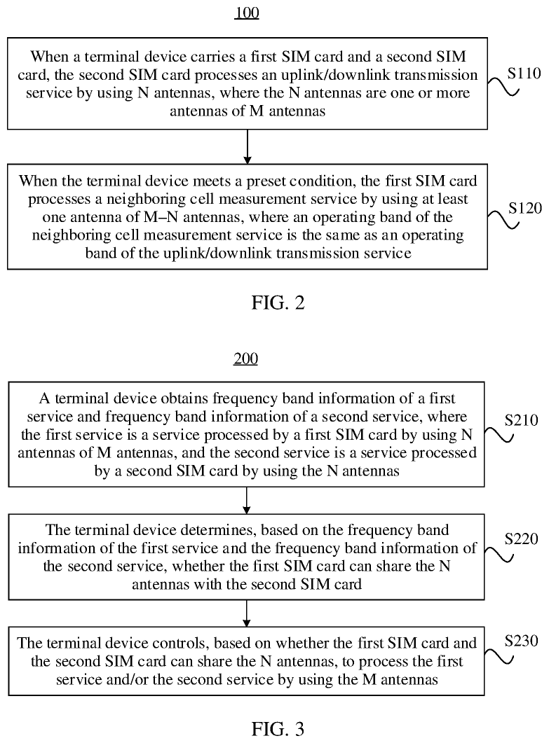

With reference to FIG. 2, the following describes a service processing method 100 mentioned in an embodiment of this application. The service processing method is applied to a terminal device. The terminal device includes M antennas. All the M antennas support signal transmission in a service operating band of a first SIM card, and some of the M antennas support signal transmission in a service operating band of a second SIM card. As shown in FIG. 2, the method 100 includes the following steps.

S110: When the terminal device carries a first SIM card and a second SIM card, the second SIM card processes an uplink/downlink transmission service by using N antennas, where the N antennas are one or more antennas of M antennas.

S120: When the terminal device meets a preset condition, the first SIM card processes a neighboring cell measurement service by using at least one antenna of M-N antennas, where an operating band of the neighboring cell measurement service is the same as an operating band of the uplink/downlink transmission service.

In some embodiments, the preset condition may include at least one of the following conditions: signal quality of a serving cell of the first SIM card is lower than a preset signal quality threshold; and the terminal device receives a measurement configuration message delivered by a network device, where the measurement configuration message indicates to measure signal quality of a neighboring cell of the serving cell.

In some embodiments, the first SIM card may be a primary SIM card (which may be briefly referred to as a primary card), and the second SIM card may be a secondary SIM card (which may be briefly referred to as a secondary card). In this case, a first service may be an inter-frequency inter-RAT measurement service, and a second service may be an uplink/downlink transmission service (which may be briefly referred to as an uplink/downlink service) between the terminal device and a base station. It should be noted that service types of the first service and the second service are not limited in this embodiment of this application. For example, the first service may be an inter-frequency inter-RAT measurement service, and the second service may be a device-to-device (device-to-device, D2D) data transmission service between the terminal device and another terminal device. Certainly, in this embodiment of this application, the first service and the second service may alternatively be any other service that meets an actual use requirement. This may be specifically determined based on the actual use requirement, and is not limited in this embodiment of this application.

For ease of description, the following describes the service processing method provided in this embodiment of this application by using an example in which the first SIM card is a primary card, the second SIM card may be a secondary card, the first service is an inter-frequency inter-RAT measurement service, and the second service is an uplink/downlink transmission service. It should be noted that, it is assumed that for an operating band corresponding to the inter-frequency inter-RAT measurement service, the M antennas are all available, in other words, the primary card may receive a measurement signal by using at least one antenna of the M antennas; and for an operating band corresponding to the uplink/downlink transmission service of the secondary card, some of the M antennas are available, in other words, the secondary card may transmit a signal by using some preset antennas of the M antennas. For example, the dual-SIM terminal device includes four antennas (M=4), where four antennas in an operating band of a service of the primary card support signal transmission, and two antennas in an operating band of a service of the secondary card support signal transmission.

The solution of this application relates to the following: In a scenario in which the primary card needs to process the inter-frequency inter-RAT measurement service when the secondary card processes the uplink/downlink transmission service, to ensure that the two cards can process services in parallel and do not affect each other, the terminal device first determines whether the service of the primary card conflicts with the service of the secondary card, and further determines, based on a determining result, a policy of using an antenna by the primary card and the secondary card, to avoid signal crosstalk. A basis for determining whether a service of the primary card conflicts with a service of the secondary card is as follows: For a current frequency band combination in which the primary card and the secondary card work, it is checked whether a radio frequency front end has two mutually independent radio frequency channels respectively used by the primary card and the secondary card. If yes, it is considered that the services of the two cards do not conflict; or if no, it is considered that the services of the two cards conflict.

It should be further noted that the primary card entity may include a plurality of functional units, for example, a receiving unit configured to receive a signal and a sending unit configured to send a signal, or a transceiver integration unit configured to receive and/or send a signal. Likewise, the secondary card entity may include a plurality of functional units, for example, a receiving unit configured to receive a signal and a sending unit configured to send a signal, or a transceiver integration unit configured to receive and/or send a signal.

In some embodiments, the foregoing M antennas may be a plurality of primary and diversity antennas, and each primary and diversity antenna includes a primary antenna (primary antenna) and a diversity antenna (diversity antenna). For example, the M antennas are two primary and diversity antennas (that is, M is 4), which are respectively referred to as a first primary and diversity antenna (namely, a primary and diversity antenna) and a second primary and diversity antenna (namely, a MIMO primary and diversity antenna). The first primary and diversity antenna includes a primary antenna and a diversity antenna, and the second primary and diversity antenna includes a MIMO primary antenna and a MIMO diversity antenna. It should be noted that a quantity of antennas is not limited in this embodiment of this application, and the terminal device may further include more primary and diversity antennas. This may be specifically determined based on an actual use requirement, and is not limited in this embodiment of this application. For ease of description, an example in which the terminal device includes four antennas, namely, two primary and diversity antennas, is used below to describe the service processing method provided in this embodiment of this application.

For example, in this embodiment of this application, a primary receive unit (primary receive, PRX) corresponding to the primary antenna and a diversity receive unit (diversity receive, DRX) corresponding to the diversity antenna are disposed in the primary card of the terminal device, and a primary receive unit (referred to as MIMO-PRX) corresponding to the MIMO primary antenna and a MIMO diversity receive unit (referred to as MIMO-DRX) corresponding to the MIMO diversity antenna are disposed.

In some embodiments, when a signal channel between the PRX of the primary card and the primary antenna is connected, the PRX of the primary card can receive a signal received by the primary antenna. In this case, the primary antenna is occupied by the primary card. Alternatively, when a signal channel between the PRX of the primary card and the primary antenna is disconnected, the PRX of the primary card cannot receive a signal received by the primary antenna. Similarly, signal transmission between the DRX of the primary card and the diversity antenna, between the MIMO-PRX of the primary card and the MIMO primary antenna, and between the MIMO-DRX of the primary card and the MIMO diversity antenna is similar to signal transmission between the PRX of the primary card and the primary antenna. Details are not described herein.

In addition, a PRX and a DRX are also disposed in the secondary card of the terminal device. In some embodiments, when a signal channel between the PRX of the secondary card and the primary antenna is connected, the PRX of the secondary card can receive a signal received by the primary antenna. In this case, the primary antenna is occupied by the secondary card. In some embodiments, when a signal channel between the PRX of the secondary card and the MIMO primary antenna is connected, the PRX of the secondary card can receive a signal received by the MIMO primary antenna. In this case, the MIMO primary antenna is occupied by the primary card. Similarly, signal transmission between the DRX of the secondary card and the diversity antenna, and signal transmission between the DRX of the secondary card and the MIMO diversity antenna are similar to signal transmission between the PRX of the secondary card and the primary antenna. Details are not described herein.

It should be noted that a radio frequency transmit unit (transmit, TX) may be further disposed in the primary card entity and the secondary card entity respectively. For example, a TX is disposed in the secondary card. In some embodiments, when a signal channel between the TX of the secondary card and the primary antenna is connected, the TX of the secondary card can send a signal by using the primary antenna. In some embodiments, when a signal channel between the TX of the secondary card and the MIMO primary antenna is connected, the TX of the secondary card can send a signal by using the MIMO primary antenna.

In this embodiment of this application, when the secondary card is in a connected state, the secondary card usually receives or sends uplink and downlink data and processes the uplink/downlink transmission service by using one or some preset antennas (namely, the foregoing N antennas) by default. For example, when the primary card is in a standby state and the secondary card is in the connected state, the secondary card processes the uplink/downlink transmission service by using the N antennas by default. For another example, when the primary card is in a connected state and the secondary card is in the connected state, the secondary card processes the uplink/downlink transmission service by using the N antennas by default.

In this embodiment of this application, when the secondary card is in the standby state, the primary card usually processes the neighboring cell measurement service by using one or some preset antennas (for example, the N antennas, or including the N antennas).

For example, the foregoing preset N antennas are primary and diversity antennas, or may be any other possible antennas. This may be specifically determined based on an actual use requirement, and is not limited in this embodiment of this application. For ease of description, the following uses an example in which the N antennas are primary and diversity antennas for description.

In this embodiment of this application, if the primary card needs to perform neighboring cell measurement when the secondary card is working, if an operating band of the neighboring cell measurement service is the same as an operating band of the uplink/downlink transmission service of the secondary card, the terminal device may determine that the primary card needs to perform neighboring cell measurement by using an antenna different from an antenna used by the secondary card.

Specifically, when the terminal device detects a communication service (an incoming call or an outgoing call) of the secondary card, the terminal device may allocate a primary and diversity antenna to the secondary card, to transmit uplink and downlink data of the communication service. Further, when the terminal device meets the preset condition to trigger the primary card to perform neighboring cell measurement, and the operating band of the neighboring cell measurement service is the same as the operating band of the uplink/downlink transmission service of the secondary card, signal crosstalk occurs in signals with a same frequency band in an antenna receive channel. Therefore, when the measurement frequency band of the primary card is the same as the operating band of the secondary card, it may be determined that a conflict occurs if the primary card and the secondary card share an antenna. Therefore, the terminal device may allocate a MIMO primary and diversity antenna to the primary card, in other words, the primary card may use an antenna that is different from an antenna occupied by the secondary card to perform neighboring cell measurement.

M and N are both integers greater than 1, and M is greater than or equal to N. The M-N antennas refer to an antenna other than the N antennas in the M antennas. For example, when the M antennas include a primary and diversity antenna and a MIMO primary and diversity antenna, and the N antennas occupied by the secondary card are primary and diversity antennas, the M-N antennas allocated by the terminal device to the primary card may be MIMO primary and diversity antennas. For another example, when the M antennas include a primary and diversity antenna and a MIMO primary and diversity antenna, and the N antennas occupied by the secondary card are primary antennas, the M-N antennas allocated by the terminal device to the primary card may be MIMO primary and diversity antennas. A policy of allocating, by the terminal device, an antenna to the primary card based on the antenna used by the secondary card is described in detail in the following.

According to the service processing method provided in this embodiment of this application, when the terminal device carries a primary card and a secondary card, the secondary card processes an uplink/downlink transmission service by using N antennas by default. When the primary card is triggered to perform neighboring cell measurement (namely, inter-frequency inter-RAT measurement), and a measurement frequency band is the same as an operating band of the secondary card, the primary card may select antennas different from N antennas used by the secondary card to perform neighboring cell measurement. Because signal crosstalk occurs in signals with a same frequency band in an antenna receive channel, when the measurement frequency band of the primary card is the same as the operating band of the secondary card, it can be determined that a conflict occurs if the primary card and the secondary card share an antenna. Therefore, the primary card may perform neighboring cell measurement by using an antenna different from an antenna occupied by the secondary card, so as to ensure that the two cards can process services in parallel and do not affect each other, thereby resolving a current problem that signal crosstalk is caused when two cards in the terminal device share an antenna to process services in parallel.

With reference to FIG. 3, the following describes another service processing method 200 mentioned in an embodiment of this application. As shown in FIG. 3, the method 200 includes the following steps.

S210: A terminal device obtains frequency band information of a first service and frequency band information of a second service, where the first service is a service processed by a first SIM card by using N antennas of M antennas, and the second service is a service processed by a second SIM card by using the N antennas.

The frequency band information of the first service indicates an operating band of the first service, and the frequency band information of the second service indicates an operating band of the second service. For ease of description, the operating band of the first service is referred to as a first frequency band for short, and the operating band of the second service is referred to as a second frequency band for short.

When a primary card processes an inter-frequency inter-RAT measurement service and a secondary card processes an uplink/downlink transmission service, one or some antennas of the terminal device may be occupied by both the primary card and the secondary card (that is, the antennas are shared). In this case, signal crosstalk may occur, and in this case, the primary card and the secondary card cannot share an antenna. Alternatively, signal crosstalk may not occur, and in this case, the primary card and the secondary card can share an antenna. In other words, the terminal device needs to determine whether the primary card and the secondary card can share an antenna.

The following uses an example in which the terminal device includes four antennas (M=4) to describe possible cases in which an antenna is shared. In some embodiments, N is 1. In this case, the primary card and the secondary card may share one antenna (such as a primary antenna). In some embodiments, N is 2. In this case, the primary card and the secondary card may share two antennas (such as a primary antenna and a diversity antenna). In some embodiments, N is 3. In this case, the primary card and the secondary card may share three antennas (such as a primary antenna, a diversity antenna, and a MIMO primary antenna). In some embodiments, N is 4. In this case, the primary card and the secondary card may share all antennas (a primary antenna, a diversity antenna, a MIMO primary antenna, and a MIMO diversity antenna). The N antennas may be antennas preset by the terminal device for a service of the primary card and/or a service of the secondary card. For example, the terminal device usually presets a primary and diversity antenna for the service of the primary card and/or the service of the secondary card. It should be noted that, in this embodiment of this application, a specific antenna or antennas that may conflict with each other when the primary card and the secondary card process services in parallel are not limited, and may be specifically determined based on an actual situation.

S220: The terminal device determines, based on the frequency band information of the first service and the frequency band information of the second service, whether the first SIM card can share an antenna with the second SIM card.

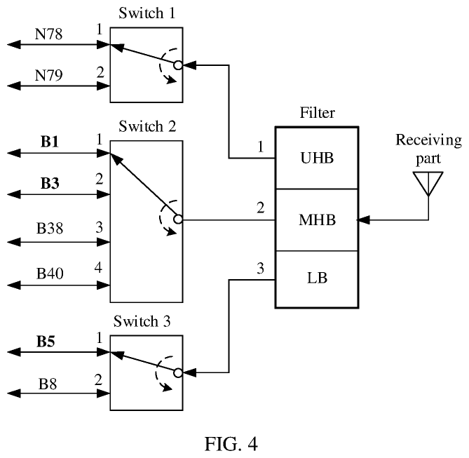

In this embodiment of this application, a basis for determining, by the terminal device, whether a service of the primary card conflicts with a service of the secondary card is as follows: For a current frequency band combination in which the primary card and the secondary card work, it is checked whether a radio frequency front end has two mutually independent radio frequency channels respectively used by the primary card and the secondary card. If yes, it is considered that the services of the two cards do not conflict; or if no, it is considered that the services of the two cards conflict. Specifically, how the terminal device determines whether the N shared antennas conflict is related to a front-end radio frequency channel design. That is, assuming that the terminal device can allocate two mutually independent radio frequency channels to service frequency bands of the primary card and the secondary card, the two cards can implement normal processing of respective services by using a shared antenna. Otherwise, if the two radio frequency channels allocated for the service frequency bands of the primary card and the secondary card are not independent, signal crosstalk occurs when the primary card and the secondary card share an antenna. In this case, the primary card and the secondary card cannot share an antenna. With reference to FIG. 4, the following uses a process of processing after receiving a signal by an antenna as an example to illustrate a principle of determining whether a conflict occurs based on an operating band. For example, the radio frequency front end of the antenna designs three independent channels for a low band (low band, LB), a middle high band (middle high band, MHB), and an ultra-high band (ultra-high band, UHB).

As shown in FIG. 4, the antenna radio frequency front end includes a receiving part, a filter, and a switch (for example, a switch 1, a switch 2, and a switch 3 in FIG. 4) for channel switching. Signals received by the receiving part first pass through the filter, and then pass through the switch. The filter filters and outputs the received signals by frequency bands. For example, the filter may filter the signals according to the UHB, the MHB, and the LB, and signals of different frequency bands are respectively output from a port 1, a port 2, and a port 3 of the filter.

In one aspect, the antenna receives signals of different frequency bands, for example, B1 and B5, where B1 belongs to the MHB, and B5 belongs to the LB. If the received signals include a signal of B1 and a signal of B5, after the signals pass through the filter, the signal of B1 is output from the port 2 of the filter, and the signal of B5 is output from the port 3 of the filter. The two signals can be output at the same time without a conflict. In other words, no conflict occurs when there are different frequency bands.

In another aspect, the antenna receives signals of a same frequency band, for example, B1 and B3, which both belong to the MHB. If the received signals include a signal of B1 and a signal of B3, after the signals pass through the filter, the signal of B1 and the signal of B3 are both output from the port 2 of the filter and enter the switch 2. Because the switch 2 can only connect to one path, either the port 1 is connected to and the signal of B1 is reserved, or the port 2 is connected to and the signal of B3 is reserved. That is, the two signals cannot be output at the same time. If the two signals are output at the same time, a conflict occurs. In other words, a conflict occurs when there is a same frequency band.

With reference to the front-end radio frequency channel shown in FIG. 4, the following describes, by using an example, how to determine whether a conflict occurs when two cards share an antenna. For example, the step of determining whether a conflict occurs when two cards share an antenna in S220 may include the following two possible implementations.

Manner 1: If the first frequency band is different from the second frequency band, the terminal device determines that no conflict occurs when the first SIM card and the second SIM card share the N antennas.

For example, it is also assumed that the terminal device processes the inter-frequency inter-RAT measurement service by using the primary card through a first primary and diversity antenna, where a frequency band used by the service is the UHB; and processes the uplink/downlink transmission service by using the secondary card through the first primary and diversity antenna, where a frequency band used by the service is the MHB or the LB, that is, operating bands of the two cards are different. The terminal device may allocate two mutually independent radio frequency channels to service frequency bands of the primary card and the secondary card. With reference to the radio frequency channels in FIG. 4, in a case of a frequency band combination (primary card UHB+secondary card MHB) or a frequency band combination (primary card UHB+secondary card LB), the radio frequency front end has two independent radio frequency channels for the primary card and the secondary card respectively. Therefore, no conflict occurs when the primary card and the secondary card share the first primary and diversity antenna.

For another example, if the frequency band corresponding to the measurement service processed by the primary card is the MHB, and the frequency band corresponding to the data transmission service processed by the secondary card is the UHB or the LB, that is, the operating bands of the two cards are different, the terminal device may allocate two mutually independent radio frequency channels to the service frequency bands of the primary card and the secondary card. With reference to the radio frequency channels in FIG. 4, in a case of a frequency band combination (primary card MHB+secondary card UHB) or a frequency band combination (primary card MHB+secondary card LB), the radio frequency front end has two independent radio frequency channels for the primary card and the secondary card respectively. Therefore, no conflict occurs when the primary card and the secondary card share the first primary and diversity antenna.

For another example, if the frequency band corresponding to the measurement service processed by the primary card is the LB, and the frequency band corresponding to the data transmission service processed by the secondary card is the UHB or the MHB, that is, the operating bands of the two cards are different, the terminal device may allocate two mutually independent radio frequency channels to the service frequency bands of the primary card and the secondary card. With reference to the radio frequency channels in FIG. 4, in a case of a frequency band combination (primary card LB+secondary card UHB) or a frequency band combination (primary card LB+secondary card MHB), the radio frequency front end has two independent radio frequency channels for the primary card and the secondary card respectively. Therefore, no conflict occurs when the primary card and the secondary card share the first primary and diversity antenna.

Manner 2: If the first frequency band is the same as the second frequency band, the terminal device determines that a conflict occurs when the first SIM card and the second SIM card share the N antennas.

For example, it is assumed that the terminal device processes the inter-frequency inter-RAT measurement service by using the primary card through the first primary and diversity antenna, and the frequency band used by the service is the UHB; and processes the uplink/downlink transmission service by using the secondary card through the first primary and diversity antenna, and the frequency band used by the service is the UHB, that is, the operating bands of the two cards are the same. It can be learned with reference to the radio frequency channels shown in FIG. 4 that, in a case of a frequency band combination (primary card UHB+secondary card UHB), the radio frequency front end does not have two mutually independent radio frequency channels for the primary card and the secondary card respectively. Therefore, a conflict occurs when the primary card and the secondary card share the first primary and diversity antenna.

For another example, if the frequency band corresponding to the inter-frequency inter-RAT measurement service processed by the primary card is the MHB, and the frequency band corresponding to the uplink/downlink transmission service processed by the secondary card is the MHB, that is, the operating bands of the two cards are the same, it can be learned with reference to the radio frequency channels shown in FIG. 4 that, in a case of a frequency band combination (primary card MHB+secondary card MHB), the radio frequency front end does not have two mutually independent radio frequency channels for the primary card and the secondary card respectively. Therefore, a conflict occurs when the primary card and the secondary card share the first primary and diversity antenna.

For another example, if the frequency band corresponding to the inter-frequency inter-RAT measurement service processed by the primary card is the LB, and the frequency band corresponding to the uplink/downlink transmission service processed by the secondary card is the LB, that is, the operating bands of the two cards are the same, it can be learned with reference to the radio frequency channels shown in FIG. 4 that, in a case of a frequency band combination (primary card LB+secondary card LB), the radio frequency front end does not have two mutually independent radio frequency channels for the primary card and the secondary card respectively. Therefore, a conflict occurs when the primary card and the secondary card share the first primary and diversity antenna.

It should be noted that for specific frequency distribution and division of the UHB, the MHB, and the LB, refer to detailed descriptions of frequency band division in a related technology. This is not limited in this embodiment of this application.

It should be noted that the foregoing uses the UHB, the MHB, and the LB as an example for description. It may be understood that the solution provided in this embodiment of this application includes but is not limited to dividing frequency bands into the UHB, the MHB, and the LB. In actual implementation, the frequency bands may be further divided in another manner. This may be specifically determined based on an actual use requirement, and is not limited in this embodiment of this application. Determining whether a conflict occurs when an antenna is shared by determining whether an operating band of a service of the primary card is the same as an operating band of a service of the secondary card falls within the protection scope of the solutions of this application.

S230: The terminal device controls, based on whether the first SIM card and the second SIM card can share the N antennas, to process the first service and/or the second service by using the M antennas.

In some embodiments, S230 may include the following three possible implementations.

Manner 1: When a conflict occurs when the first SIM card and the second SIM card share the N antennas, and N is less than M, the terminal device controls to process the first service and the second service by using different antennas in the M antennas.

For example, M is 4 and N is 2. For a dual-SIM terminal device, it is assumed that four antennas in an operating band of a primary card support receiving. When a frequency band corresponding to an inter-frequency inter-RAT measurement service is the same as a frequency band corresponding to an uplink/downlink transmission service, a conflict occurs when the primary card and the secondary card share an antenna (such as a first primary and diversity antenna). To ensure that the two cards can process services in parallel and do not affect by each other, the terminal device may control different antennas in the four antennas to process the inter-frequency inter-RAT measurement service and the uplink/downlink transmission service. For example, the inter-frequency inter-RAT measurement service occupies the first primary and diversity antenna, and the uplink/downlink transmission occupies a MIMO primary and diversity antenna, to avoid a conflict of sharing an antenna. In this way, the inter-frequency inter-RAT measurement service and the uplink/downlink transmission service separately occupy different antennas for signal transmission, and therefore no signal crosstalk is caused.

Manner 2: When a conflict occurs when the first SIM card and the second SIM card share the N antennas, and N is equal to M, the terminal device controls to process the first service and the second service by using the M antennas in a time-division manner.

For example, M is 4 and N is 4. When the frequency band corresponding to the inter-frequency inter-RAT measurement service is the same as the frequency band corresponding to the uplink/downlink transmission service, a conflict occurs when the primary card and the secondary card share the four antennas. In this case, the terminal device may control to process the inter-frequency inter-RAT measurement service and the uplink/downlink transmission service by using the four antennas in a time-division manner. For example, a signal corresponding to the inter-frequency inter-RAT measurement service is first received by using the four antennas, and then a signal corresponding to the uplink/downlink transmission service is transmitted by using the four antennas after the measurement service ends. In this way, the two services occupy the antennas in a time-division manner, to avoid a conflict of shared antennas. In this way, the inter-frequency inter-RAT measurement service and the uplink/downlink transmission service occupy an antenna for signal transmission in a time-division manner, and therefore no signal crosstalk is caused.

Manner 3: When no conflict occurs when the first SIM card and the second SIM card share the N antennas, the terminal device controls to process the first service and/or the second service by using the N antennas.

In this embodiment of this application, in a dual-card service process, if an antenna of inter-frequency inter-RAT measurement by the primary card does not conflict with an antenna of the service of the secondary card, the service of the secondary card does not need to be suppressed. For example, there are four available receive antennas for a target measurement frequency of the primary card, and the primary card may find two antennas that do not conflict with the service of the secondary card for measurement. In this scenario, the service of the secondary card does not need to be suppressed, so that the measurement service of the primary card is processed in parallel with the uplink/downlink service of the secondary card. For another example, there are only two available receive antennas for the target measurement frequency of the primary card, but the target measurement frequency and the service frequency of the secondary card can coexist (for example, in a scenario in which the primary card is of the MHB and the secondary card is of the LB). In this scenario, the service of the secondary card does not need to be suppressed, so that the measurement service of the primary card is processed in parallel with the uplink/downlink service of the secondary card.

For example, an example in which M is 4 and N is 2 is still used. If the measurement frequency of the primary card corresponds to a 4R antenna, when the frequency band corresponding to the inter-frequency inter-RAT measurement service is different from the frequency band corresponding to the uplink/downlink transmission service, and the primary card and the secondary card share two antennas (for example, the first primary and diversity antenna) without a conflict, the terminal device may control the two antennas to process the inter-frequency inter-RAT measurement service and/or the uplink/downlink transmission service. For example, the inter-frequency inter-RAT measurement service of the primary card and the uplink/downlink transmission service of the secondary card may simultaneously occupy the two antennas to transmit signals, in other words, the measurement service of the primary card and the uplink and downlink services of the secondary card can be simultaneously processed. In this way, because the primary card and the secondary card share the antennas without a conflict, the inter-frequency inter-RAT measurement service and the uplink/downlink transmission service may occupy a same antenna (certainly, different antennas may alternatively be occupied) for signal transmission. Therefore, no signal crosstalk is caused.

In conclusion, in one aspect, in a scenario described in Manner 1 in which the primary card measurement frequency band has a 4R antenna and the secondary card occupies a part of all antennas (in other words, the operating bands of the two services are the same, for example, the primary card is of the MHB and the secondary card is of the MHB, and in this case, the services of the two cards cannot coexist), the measurement service of the primary card and the uplink/downlink service of the secondary card are processed by using different antennas. Alternatively, in a scenario described in Manner 3 in which the antenna of the measurement service of the primary card does not conflict with the antenna of the uplink/downlink service of the secondary card (in other words, the operating bands of the two services are different, for example, the primary card is of the MHB and the secondary card is of the LB, and in this case, the services of the two cards can coexist), the terminal device does not need to suppress the service of the secondary card in a measurement process of the primary card, so that the service of the secondary card can be normally performed. In another aspect, in the scenario described in Manner 2 in which the secondary card occupies all antennas, the service is processed by using an antenna in a time-division manner (for example, the primary card preferentially preempts an antenna). In this case, the terminal device suppresses the service of the secondary card in a measurement process of the primary card, and the service of the secondary card is restored after the measurement service of the primary card ends.

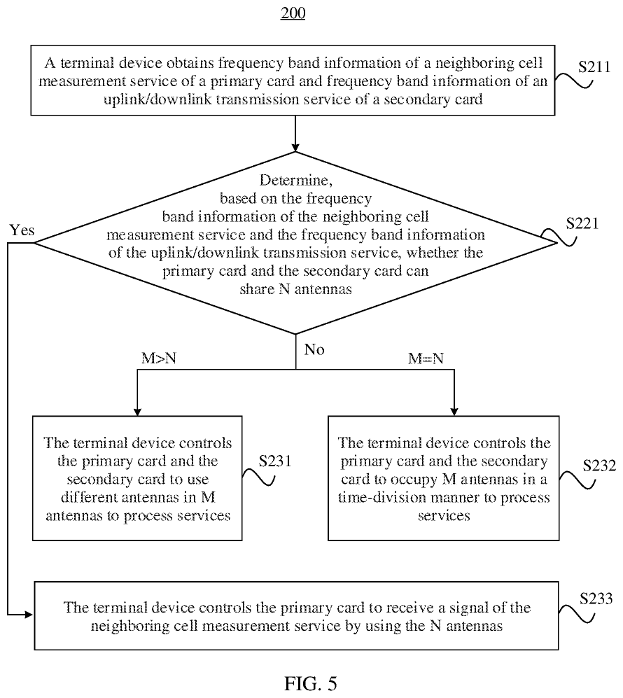

With reference to the foregoing descriptions of S210 to S230, that the first SIM card is the primary card, the second SIM card is the secondary card, the first service is the inter-frequency inter-RAT measurement service, and the second service is the uplink/downlink service is used as an example. With reference to FIG. 3, as shown in FIG. 5, S210 to S230 may be specifically implemented by using the following S211 to S233.

S211: A terminal device obtains frequency band information of a neighboring cell measurement service of a primary card and frequency band information of an uplink/downlink transmission service of a secondary card.

When the secondary card processes the uplink/downlink transmission service by using N antennas of M antennas, if the terminal device meets a preset condition, the terminal device may obtain the frequency band information of services of the two cards, and further determine, based on the frequency band information of the services of the two cards, whether the two cards can share an antenna.

S221: The terminal device determines, based on the frequency band information of the neighboring cell measurement service and the frequency band information of the uplink/downlink transmission service, whether the primary card and the secondary card can share the N antennas.

When a conflict occurs when the primary card and the secondary card share the N antennas, and N is less than M, the terminal device performs the following S231. When a conflict occurs when the primary card and the secondary card share the N antennas, and N is equal to M, the terminal device performs the following S232. When no conflict occurs when the primary card and the secondary card share the N antennas, the terminal device performs the following S233.

S231: The terminal device controls the primary card and the secondary card to use different antennas in the M antennas to process respective services.

In S231, when some antennas may conflict when being shared, the neighboring cell measurement service and the uplink/downlink transmission service occupy different antennas respectively to avoid a conflict.

S232: The terminal device controls the primary card and the secondary card to occupy the M antennas in a time-division manner to process respective services.

In S232, when all antennas may conflict when being shared, the inter-frequency inter-RAT measurement service of the primary card and the uplink/downlink transmission service of the secondary card occupy the antennas in a time-division manner, to avoid a conflict.

S233: The terminal device controls the primary card to receive a signal of the neighboring cell measurement service by using the N antennas.

In S233, when no conflict of sharing an antenna exists, if the neighboring cell measurement service is initiated, the terminal device may control to process the neighboring cell measurement service by using the N antennas. When no conflict of sharing an antenna exists, if the uplink/downlink transmission service is initiated, the terminal device controls to process the uplink/downlink transmission service by using the N antennas. When no conflict of sharing an antenna exists, the terminal device may control to process the neighboring cell measurement service and the uplink/downlink transmission service by using the N antennas.

The following uses an example for description. It is assumed that the dual-SIM terminal device controls both the primary card and the secondary card to work in an MHB to camp on a network. For example, the primary card camps on B1, and the secondary card camps on B3.

For example, the secondary card keeps in a standby state, the primary card starts to perform a service and enters a connected state, and the primary card is triggered to start to perform inter-frequency inter-RAT measurement. A target measurement frequency band is the MHB, for example, B38. A test can verify antennas used by the primary SIM card for measurement. Generally, the PRX and the DRX are used for measurement. Further, the secondary card starts to make a VoLTE call, the primary card keeps in the connected state, and the primary card is triggered to start to perform inter-frequency inter-RAT measurement. A target measurement frequency band is also the MHB, for example, B38. Based on the solution of this application, because the MHB of the primary card conflicts with the MHB of the secondary card, the primary card may perform measurement by using the MIMO-PRX and the MIMO-DRX, so that the primary card and the secondary card do not conflict.

For another example, the secondary card keeps in the standby state, the primary card starts to perform a service and enters the connected state, and the primary card is triggered to start to perform inter-frequency inter-RAT measurement. A target measurement frequency band is the UHB, for example, N78. A test can verify antennas used by the primary card for measurement. Generally, the PRX and the DRX are used for measurement. Further, the secondary card starts to make a VoLTE call, the primary card keeps in the connected state, and the primary card is triggered to start to perform inter-frequency inter-RAT measurement. A target measurement frequency band is the UHB, for example, N78. Based on the solution of this application, because the UHB of the primary card does not conflict with the MHB of the secondary card, the primary card may still perform measurement by using the PRX and the DRX.

In this embodiment of this application, when the terminal device performs inter-frequency inter-RAT measurement scheduling by using the primary card, the terminal device first determines whether the measurement service of the primary card and the uplink/downlink transmission service of the secondary card can coexist, and then determines, based on a determining result, whether to suppress the uplink/downlink transmission service of the secondary card in a measurement process of the primary card. Specifically, in one aspect, when the operating bands corresponding to the two services are different, the two services can coexist, and the uplink/downlink transmission service of the secondary card does not need to be suppressed in the measurement process of the primary card. In another aspect, when the operating bands corresponding to the two services are the same, the two services cannot coexist, and the uplink/downlink transmission service of the secondary card is suppressed in the measurement process of the primary card.

The foregoing describes, by using an example in which the terminal device supports four antennas, the service processing method provided in this embodiment of this application, and separately describes how to allocate an antenna to process a service in a case in which a conflict occur when some of the four antennas are shared, how to allocate an antenna to process a service in a case in which a conflict occur when all of the four antennas are shared, and how to allocate an antenna to process a service in a case in which no conflict occurs when the primary card and the secondary card share any of the four antennas. The following describes in detail how to allocate an antenna to process a service when a conflict occurs.

In this embodiment of this application, when the terminal device detects that the primary card performs inter-frequency inter-RAT measurement, the terminal device obtains a status of a conflict between an antenna of a target measurement frequency band and an antenna of a current operating band of the secondary card, and selects an antenna that does not conflict to perform measurement reception. If the target measurement frequency band and the current operating band of the secondary card can simultaneously share an antenna, an antenna (such as a primary and diversity antenna) that does not conflict is selected for reception. For example, in a frequency band combination in which the primary card is of the MHB and the secondary card is of the LB, and in a frequency band combination in which the primary card is of sub-6G and the secondary card is of sub-3G, measurement reception of the primary card and service reception of the secondary card can be processed in parallel. If the measurement target frequency band and the current operating band of the secondary card cannot simultaneously share the antenna, and there are four available receive antennas for the measurement target frequency band of the primary card, a measurement antenna is selected based on the status of the antenna conflict. In this embodiment of this application, a case in which a conflict occurs when some antennas are shared may be a conflict when one of the four antennas is shared, a conflict when two antennas are shared, or a conflict when three antennas are shared. The following separately describes possible implementations in the different cases.

Case 1: For a case in which a conflict occurs when one of the four antennas is shared, the following Table 1 lists several possible processing manners in this case in a list manner. If one receive antenna in the measurement frequency band of the primary card conflicts with the secondary card, the primary card selects two antennas that do not conflict in a same channel to perform inter-frequency inter-RAT measurement. Specifically, when the secondary card occupies an antenna for processing the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When determining that a conflict occurs, the terminal device may allocate an antenna that does not conflict with the secondary card to the primary card. In this way, signal crosstalk caused by the conflict of sharing an antenna may be avoided.

TABLE 1

| | Antenna selected for measurement by a |
|---|---|
| Antenna conflict status | primary card |
| Primary antenna | MIMO primary and diversity antenna |
| Diversity antenna | MIMO primary and diversity antenna |
| MIMO primary antenna | Primary and diversity antenna |
| MIMO diversity antenna | Primary and diversity antenna |

It should be noted that a primary antenna and a diversity antenna form a primary and diversity antenna, that is, the first primary and diversity antenna; and a MIMO primary antenna and a MIMO diversity antenna form a MIMO primary and diversity antenna, that is, a second primary and diversity antenna.

With reference to Table 1, a possible implementation of S231 may be any one of the following manner 1 to manner 4.

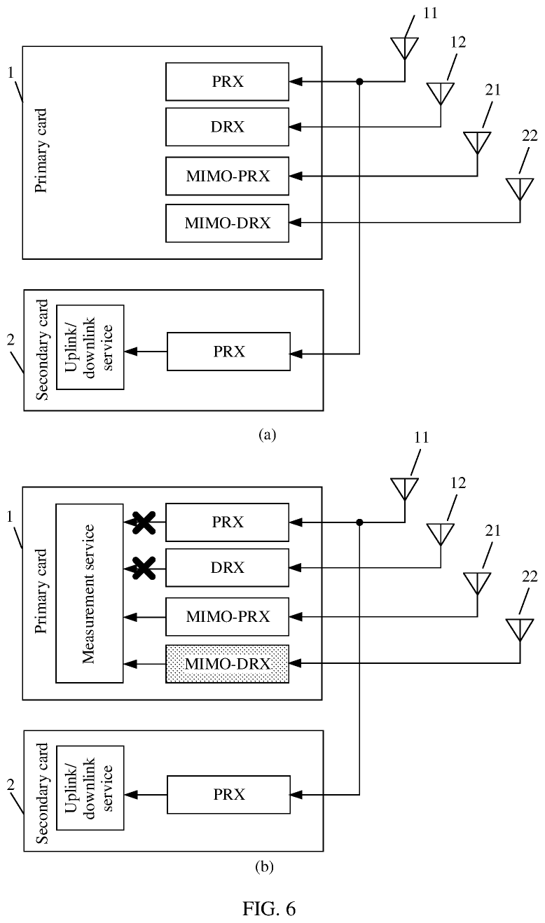

Manner 1: When the secondary card occupies the primary antenna and a conflict occurs when the primary card and the secondary card share an antenna, the terminal device controls the primary card to receive a signal of the inter-frequency inter-RAT measurement service by using the MIMO primary and diversity antenna. For example, as shown in (a) in FIG. 6, for a dual-SIM terminal device, it is assumed that four antennas in an operating band of a primary card support reception. When a secondary card 2 occupies a primary antenna 11 to process an uplink/downlink transmission service, if the primary card 1 needs to perform inter-frequency inter-RAT measurement (that is, process an inter-frequency inter-RAT measurement service), the terminal device may determine, based on frequency band information of the two services, whether a conflict occurs when the primary card 1 and the secondary card 2 share an antenna. When it is determined that there is a conflict, to ensure that the two cards can process services in parallel and do not affect each other, the terminal device may allocate an antenna that does not conflict with the secondary card 2 to the primary card 1, for example, a MIMO primary and diversity antenna 21 and 22. Specifically, as shown in (b) in FIG. 6, the terminal device may control the primary card 1 to receive a signal of the inter-frequency inter-RAT measurement service by using the MIMO primary and diversity antenna 21 and 22. In this case, the secondary card 2 still occupies the primary antenna 11. This avoids signal crosstalk caused by a conflict of sharing an antenna.

Manner 2: When the secondary card occupies the diversity antenna and a conflict occurs when the primary card and the secondary card share an antenna, the terminal device controls the primary card to receive a signal of the inter-frequency inter-RAT measurement service by using the MIMO primary and diversity antenna. For example, when the secondary card occupies the diversity antenna to process the uplink/downlink transmission service, if the primary card needs to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the MIMO primary and diversity antenna. Specifically, the terminal device may control to receive a signal of the inter-frequency inter-RAT measurement service by using the MIMO primary and diversity antenna. In this case, the secondary card still occupies the diversity antenna. This avoids signal crosstalk caused by a conflict of sharing an antenna.

Manner 3: When the secondary card occupies the MIMO primary antenna and a conflict occurs when the primary card and the secondary card share an antenna, the terminal device controls the primary card to receive a signal of the inter-frequency inter-RAT measurement service by using the primary and diversity antenna. For example, when the secondary card occupies the MIMO primary antenna to process the uplink/downlink transmission service, if the primary card needs to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the primary and diversity antenna. Specifically, the terminal device may control the primary card to receive a signal of the inter-frequency inter-RAT measurement service by using the primary and diversity antenna. In this case, the secondary card still occupies the MIMO primary antenna. This avoids signal crosstalk caused by a conflict of sharing an antenna.

Manner 4: When the secondary card occupies the MIMO primary antenna and a conflict occurs when the primary card and the secondary card share an antenna, the terminal device controls the primary card to receive a signal of the inter-frequency inter-RAT measurement service by using the primary and diversity antenna. For example, when the secondary card occupies the MIMO diversity antenna to process the uplink/downlink transmission service, if the primary card needs to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the primary and diversity antenna. Specifically, the terminal device may control the primary card to receive a signal of the inter-frequency inter-RAT measurement service by using the primary and diversity antenna. In this case, the secondary card still occupies the MIMO diversity antenna. This avoids signal crosstalk caused by a conflict of sharing an antenna.

In the conventional technology, a primary and diversity antenna is always used for inter-frequency inter-RAT measurement, and a conflict between services of a primary card and a secondary card cannot be avoided when the primary card and the secondary card process services in parallel. Compared with the conventional technology, in this embodiment of this application, an antenna that does not conflict may be dynamically selected to perform inter-frequency inter-RAT measurement based on an antenna conflict status of frequency bands of two cards, so as to avoid a conflicting antenna, thereby avoiding signal crosstalk.

Case 2: For a case in which a conflict occurs when two of the four antennas are shared, the following Table 2 lists several possible processing manners in this case as an example in a list manner. If two antennas in a measurement frequency band of the primary card conflict with the secondary card, an antenna that does not conflict is selected for measurement. For example, when the secondary card occupies two antennas to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card. In this way, signal crosstalk caused by a conflict of sharing an antenna can be avoided.

TABLE 2

| | Antenna used for measurement |
|---|---|
| Antenna conflict status | by a primary card |
| Primary and diversity | MIMO primary and diversity |
| antenna | antenna |
| MIMO primary and diversity | Primary and diversity |
| antenna | antenna |
| Primary antenna and MIMO | Diversity antenna and MIMO |
| primary antenna | diversity antenna |
| Primary antenna and MIMO | Diversity antenna and MIMO |
| diversity antenna | primary antenna |
| Diversity antenna and MIMO | Primary antenna and MIMO |
| primary antenna | diversity antenna |
| Diversity antenna and MIMO | Primary antenna and MIMO |
| diversity antenna | primary antenna |

With reference to Table 2, a possible implementation of S231 may be any one of the following manner 1 to manner 6.

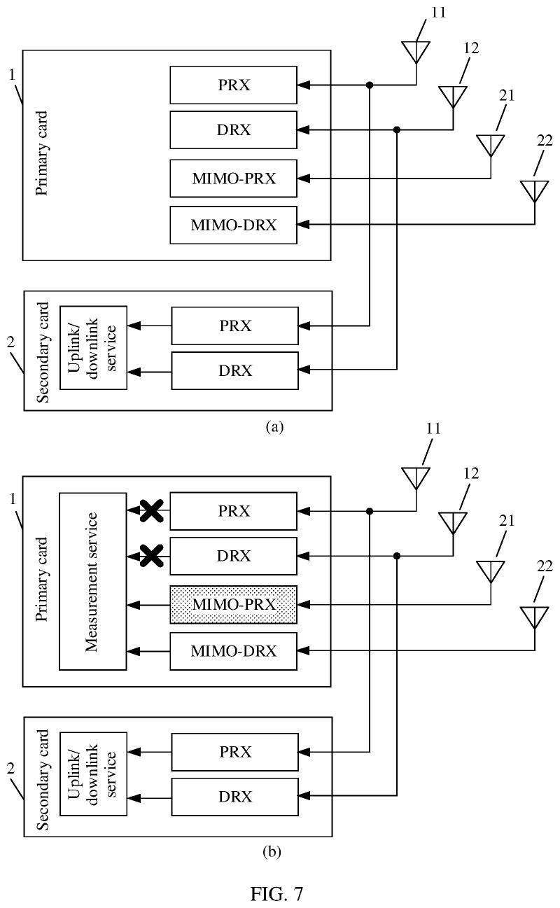

Manner 1: When the secondary card occupies the primary and diversity antenna and a conflict occurs when the primary card and the secondary card share an antenna, the terminal device controls the primary card to receive a signal of the inter-frequency inter-RAT measurement service by using the MIMO primary and diversity antenna. For example, as shown in (a) in FIG. 7, for a dual-SIM terminal device, it is assumed that four antennas in an operating band of a primary card support reception. When a secondary card 2 occupies a primary and diversity antenna 11 and 12 to process an uplink/downlink transmission service, if the primary card 1 needs to perform inter-frequency inter-RAT measurement, the terminal device may determine, based on frequency band information of the two services, whether a conflict occurs when the primary card 1 and the secondary card 2 share an antenna. When it is determined that there is a conflict, to ensure that the two cards can process services in parallel and do not affect each other, the terminal device may allocate an antenna that does not conflict with the secondary card 2 to the primary card 1, for example, a MIMO primary and diversity antenna 21 and 22. Specifically, as shown in (b) in FIG. 7, the terminal device may control the primary card 1 to receive a signal of the inter-frequency inter-RAT measurement service by using the MIMO primary and diversity antenna 21 and 22. In this case, the secondary card 2 still occupies the primary and diversity antenna 11 and 12. This avoids signal crosstalk caused by a conflict of sharing an antenna.

Manner 2: When the secondary card occupies the MIMO primary and diversity antenna and a conflict occurs when the primary card and the secondary card share an antenna, the terminal device controls the primary card to receive a signal of the inter-frequency inter-RAT measurement service by using the primary and diversity antenna. For example, when the secondary card occupies the MIMO primary and diversity antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the primary and diversity antenna. Specifically, the terminal device may control to receive a signal of the inter-frequency inter-RAT measurement service by using the primary and diversity antenna. In this case, the secondary card still occupies the MIMO primary and diversity antenna. This avoids signal crosstalk caused by a conflict of sharing an antenna.

Manner 3: When the secondary card occupies the primary antenna and the MIMO primary antenna and a conflict occurs when the primary card and the secondary card share an antenna, the terminal device controls the primary card to receive a signal of the inter-frequency inter-RAT measurement service by using the diversity antenna and the MIMO diversity antenna. For example, when the secondary card occupies the primary antenna and the MIMO primary antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the diversity antenna and the MIMO diversity antenna. Specifically, the terminal device may control to receive a signal of the inter-frequency inter-RAT measurement service by using the diversity antenna and the MIMO diversity antenna. In this case, the secondary card still occupies the primary antenna and the MIMO primary antenna. This avoids signal crosstalk caused by a conflict of sharing an antenna.

Manner 4: When the secondary card occupies the primary antenna and the MIMO diversity antenna and a conflict occurs when the primary card and the secondary card share an antenna, the terminal device controls the primary card to receive a signal of the inter-frequency inter-RAT measurement service by using the diversity antenna and the MIMO primary antenna. For example, when the secondary card occupies the primary antenna and the MIMO diversity antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the diversity antenna and the MIMO primary antenna. Specifically, the terminal device may control to receive a signal of the inter-frequency inter-RAT measurement service by using the diversity antenna and the MIMO primary antenna. In this case, the secondary card still occupies the primary antenna and the MIMO diversity antenna. This avoids signal crosstalk caused by a conflict of sharing an antenna.

Manner 5: When the secondary card occupies the diversity antenna and the MIMO primary antenna and a conflict occurs when the primary card and the secondary card share an antenna, the terminal device controls to transmit a signal of the uplink/downlink transmission service by using the diversity antenna and the MIMO primary antenna and to receive a signal of the inter-frequency inter-RAT measurement service by using the primary antenna and the MIMO diversity antenna. For example, when the secondary card occupies the diversity antenna and the MIMO primary antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the primary antenna and the MIMO diversity antenna. Specifically, the terminal device may control to receive a signal of the inter-frequency inter-RAT measurement service by using the primary antenna and the MIMO diversity antenna. In this case, the secondary card still occupies the diversity antenna and the MIMO primary antenna. This avoids signal crosstalk caused by a conflict of sharing an antenna.

Manner 6: When the secondary card occupies the diversity antenna and the MIMO diversity antenna and a conflict occurs when the primary card and the secondary card share an antenna, the terminal device controls to transmit a signal of the uplink/downlink transmission service by using the diversity antenna and the MIMO diversity antenna and to receive a signal of the inter-frequency inter-RAT measurement service by using the primary antenna and the MIMO primary antenna. For example, when the secondary card occupies the diversity antenna and the MIMO diversity antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the primary antenna and the MIMO primary antenna. Specifically, the terminal device may control to receive a signal of the inter-frequency inter-RAT measurement service by using the primary antenna and the MIMO primary antenna. In this case, the secondary card still occupies the diversity antenna and the MIMO diversity antenna. This avoids signal crosstalk caused by a conflict of sharing an antenna.

Case 3: For a case in which a conflict occurs when three of the four antennas are shared, the following Table 3 lists several possible processing manners in this case as an example in a list manner. If three antennas in a measurement frequency band of the primary card conflict with the secondary card, an antenna that does not conflict is selected for measurement. For example, when the secondary card occupies three antennas to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card. In this way, signal crosstalk caused by a conflict of sharing an antenna can be avoided.

TABLE 3

| | Antenna used for |
|---|---|
| | measurement by a |
| Antenna conflict status | primary card |
| Primary and diversity antenna and MIMO | MIMO diversity antenna |
| primary antenna | |
| Primary and diversity antenna and MIMO | MIMO primary antenna |
| diversity antenna | |
| Primary antenna and MIMO primary and | Diversity antenna |
| diversity antenna | |
| Diversity antenna and MIMO primary and | Primary antenna |
| diversity antenna | |

With reference to Table 3, a possible implementation of S231 may be any one of the following manner 1 to manner 4.

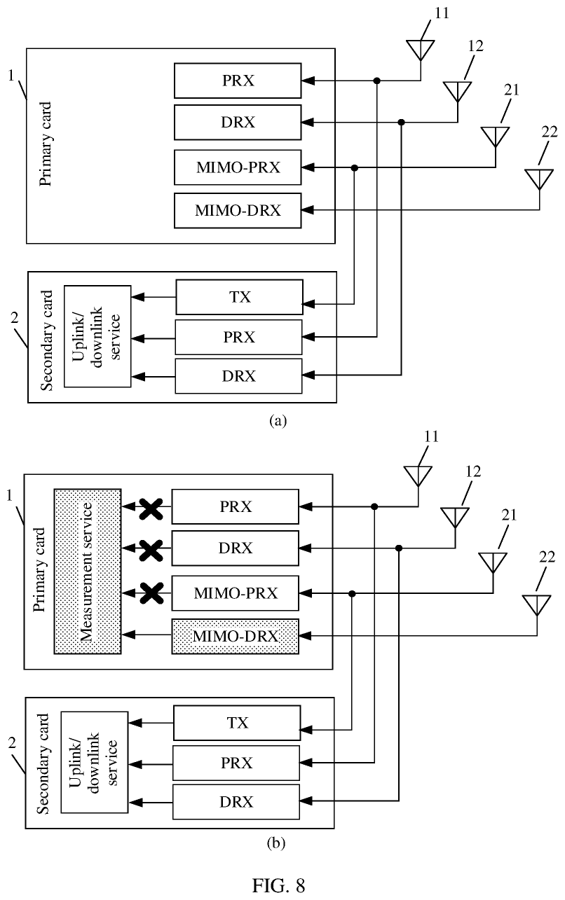

Manner 1: When the secondary card occupies the primary and diversity antenna and the MIMO primary antenna and a conflict occurs when the primary card and the secondary card share an antenna, the terminal device controls the primary card to receive a signal of the inter-frequency inter-RAT measurement service by using the MIMO diversity antenna. For example, as shown in (a) in FIG. 8, for a dual-SIM terminal device, it is assumed that there are four antennas in an operating band of a primary card support reception. When a secondary card 2 occupies a primary and diversity antenna 11 and 12 and a MIMO primary antenna 21 to process an uplink/downlink transmission service, if the primary card 1 needs to perform inter-frequency inter-RAT measurement, the terminal device may determine, based on frequency band information of the two services, whether a conflict occurs when the primary card 1 and the secondary card 2 share an antenna. When it is determined that there is a conflict, to ensure that the two cards can process services in parallel and do not affect each other, the terminal device may allocate an antenna that does not conflict with the secondary card 2 to the primary card 1, for example, a MIMO diversity antenna 22. Specifically, as shown in (b) in FIG. 8, the terminal device may control the primary card 1 to receive a signal of the inter-frequency inter-RAT measurement service by using the MIMO diversity antenna 22. In this case, the secondary card 2 still occupies the primary and diversity antenna 11 and 12 and the MIMO primary antenna 21. This avoids signal crosstalk caused by a conflict of sharing an antenna.

Manner 2: When the secondary card occupies the primary and diversity antenna and the MIMO diversity antenna and a conflict occurs when the primary card and the secondary card share an antenna, the terminal device controls the primary card to receive a signal of the inter-frequency inter-RAT measurement service by using the MIMO primary antenna. For example, when the secondary card occupies the primary and diversity antenna and the MIMO diversity antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the MIMO primary antenna. Specifically, the terminal device may control to receive a signal of the inter-frequency inter-RAT measurement service by using the MIMO primary antenna. In this case, the secondary card still occupies the primary and diversity antenna and the MIMO diversity antenna. This avoids signal crosstalk caused by a conflict of sharing an antenna.

Manner 3: When the secondary card occupies the primary antenna and the MIMO primary and diversity antenna and a conflict occurs when the primary card and the secondary card share an antenna, the terminal device controls the primary card to receive a signal of the inter-frequency inter-RAT measurement service by using the diversity antenna. For example, when the secondary card occupies the primary antenna and the MIMO primary and diversity antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the diversity antenna. Specifically, the terminal device may control to receive a signal of the inter-frequency inter-RAT measurement service by using the diversity antenna. In this case, the secondary card still occupies the primary antenna and the MIMO primary and diversity antenna. This avoids signal crosstalk caused by a conflict of sharing an antenna.

Manner 4: When the secondary card occupies the diversity antenna and the MIMO primary and diversity antenna and a conflict occurs when the primary card and the secondary card share an antenna, the terminal device controls the primary card to receive a signal of the inter-frequency inter-RAT measurement service by using the primary antenna. For example, when the secondary card occupies the diversity antenna and the MIMO primary and diversity antenna to process the uplink/downlink transmission service, and the primary card is indicated to perform inter-frequency inter-RAT measurement, the terminal device may determine, based on the frequency band information of the two services, whether a conflict occurs when the primary card and the secondary card share an antenna. When it is determined that there is a conflict, the terminal device may allocate an antenna that does not conflict with the secondary card to the primary card, for example, the primary antenna. Specifically, the terminal device may control to receive a signal of the inter-frequency inter-RAT measurement service by using the primary antenna. In this case, the secondary card still occupies the diversity antenna and the MIMO primary and diversity antenna. This avoids signal crosstalk caused by a conflict of sharing an antenna.

Based on the foregoing method, in a case in which the target frequency band of inter-frequency inter-RAT measurement by the primary card supports 4R, an antenna that does not conflict with the secondary card can be dynamically selected for measurement, so that a measurement service of the primary card and an uplink/downlink service of the secondary card can coexist.

In the conventional technology, in a process in which a primary card and a secondary card of a dual-SIM terminal perform services in parallel, the primary card may execute a rollback policy of a receive antenna to avoid a conflict with the secondary card. For example, the primary card may roll back from using a primary and diversity antenna to using only a MIMO primary and diversity antenna to perform a service, and the primary and diversity antenna is used by the secondary card. Based on the conventional technology, during inter-frequency inter-RAT measurement, the primary card always uses the primary and diversity antenna for measurement. In this way, the primary card uses the primary and diversity antenna for reception during inter-frequency inter-RAT measurement evaluation, and subsequently the primary card is handed over to the frequency and uses the MIMO primary and diversity antenna for an uplink/downlink service. Due to the difference in an antenna layout and impact of hand holding and placement on different antennas, signal strength of each antenna may differ significantly, and a difference is greater than 10 dB. For example, signal strengths of the four antennas, namely, the primary antenna, the diversity antenna, the MIMO primary antenna, and the MIMO primary antenna, are respectively −80 dBm, −85 dBm, −90 dBm, and −95 dBm. In the measurement phase, the primary SIM card uses the primary and diversity antenna for measurement. In this case, a signal strength obtained through measurement of a target frequency is −80 dBm. When the primary SIM card is handed over to the frequency band and uses the MIMO primary and diversity antenna to work, an actual signal strength is only −90 dBm, which is different from the measurement result. As a result, the signal strength after handover may be different from an expected value and ping-pong handover may occur.

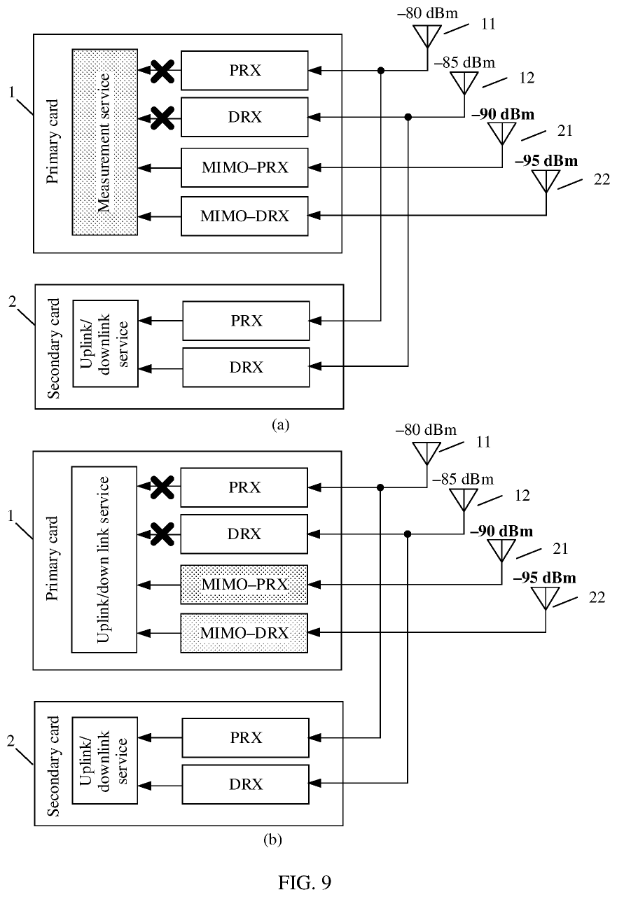

The solution provided in this embodiment of this application can resolve the foregoing problem that the measurement evaluation result is inaccurate. In this embodiment of this application, an antenna rollback policy is not used when the two cards process services in parallel. Instead, the primary card selects an antenna that does not conflict with the secondary card during inter-frequency inter-RAT measurement, and uses the antenna to perform a subsequent service. Therefore, an antenna used for measurement by the primary card is consistent with an antenna used for a subsequent service. Therefore, a measurement result of the primary card can accurately reflect quality of a subsequent service. For example, a target measurement frequency band of a primary card is an MHB, and a secondary card also works in the MHB, as shown in (a) in FIG. 9. It is assumed that signal strengths of four antennas are respectively −80 decibels (dBm), −85 dBm, −90 dBm, and −95 dBm. In a measurement process, the primary card 1 performs reception by using a MIMO primary and diversity antenna 21 and 22, and measured signal strengths are respectively −90 dBm and −95 dBm, as shown in (b) in FIG. 9. When the primary card 1 is handed over to the frequency band for uplink and downlink service demodulation, a detected signal strength is also −90 dBm and −95 dBm. That is, the measurement result of the primary card 1 can accurately evaluate the uplink and downlink service quality of the primary card. Therefore, according to the solution of this application, an antenna used for measurement can be consistent with an antenna used for subsequent handover to the frequency band to perform an uplink/downlink service, so that a measurement evaluation result is accurate.

In this embodiment of this application, when the two cards process services in parallel, the primary card dynamically selects an antenna used for inter-frequency inter-RAT measurement, and dynamically selects, based on a status of a conflict between an antenna of a target measurement frequency band and an antenna of a service frequency band of the secondary card, an antenna that does not conflict with the secondary card for measurement. In this way, in one aspect, measurement by the primary card can coexist with an uplink/downlink service of the secondary card. For example, a target measurement frequency band of the primary card is the MHB, and the secondary card also works in the MHB and occupies the primary and diversity antenna of the primary card. In this case, the MIMO primary and diversity antenna of the primary card does not conflict with the secondary card. Therefore, the terminal device may select the MIMO primary and diversity antenna to perform inter-frequency measurement. In this way, a service of the secondary card does not need to be suppressed. In another aspect, according to the solution provided in this embodiment of this application, an antenna used for measurement can be consistent with an antenna used for subsequent handover to the frequency band to perform an uplink/downlink service, so that a measurement evaluation result is accurate. For example, the primary card uses the MIMO primary and diversity for inter-frequency inter-RAT measurement. When the primary card is handed over to the frequency band, the MIMO primary and diversity antenna is also used for an uplink/downlink service, which is consistent with the measurement antenna.

The foregoing describes in detail a specific implementation when a conflict occurs when some antennas are shared, and the following describes in detail a specific implementation when a conflict occurs when all antennas are shared. Optionally, S232 includes: The terminal device controls to receive, by using the M antennas, a signal of the first service within measurement duration corresponding to the first service, stop receiving a signal of the second service, and receive the signal of the second service after the measurement duration ends.

For example, when the primary card is indicated to perform inter-frequency inter-RAT measurement (that is, process an inter-frequency inter-RAT measurement service), and all antennas of the terminal device are occupied by the secondary card in this case, the terminal device may determine, based on the frequency band information of the two services, whether a conflict occurs when the primary card and the secondary card share an antenna. When it is determined that there is a conflict, the terminal device may first process the inter-frequency inter-RAT measurement service of the primary card by using the antenna, and then process the uplink/downlink transmission service of the secondary card after the measurement service ends.

It should be noted that, when the services of the two cards cannot share an antenna because the operating bands are the same, the terminal device may perform an antenna preemption policy based on a processing priority. A service with a higher priority is preferentially processed. If a processing priority of a service of the secondary card is higher than a processing priority of a measurement service of the primary card, the terminal device may first process the service of the secondary card by using the antenna, and then process the service of the primary card after the service of the secondary card ends.

In some embodiments, in a scenario in which a conflict exists between an antenna of the target measurement frequency band of the primary card and the antenna of the frequency band of the uplink/downlink service of the secondary card, a service of the secondary card needs to be suppressed in a measurement process. In this case, impact of the suppression operation on the service of the secondary card is reduced by reducing a measurement proportion. Specifically, when the first SIM card and the second SIM card share the N antennas and N is equal to M, in other words, all antennas are shared and a conflict occurs, to avoid a conflict between inter-frequency inter-RAT measurement by the primary card and the uplink/downlink service of the secondary card, the uplink/downlink service of the secondary card needs to be suppressed in a measurement process of the primary card, and the terminal device can reduce a measurement proportion corresponding to the first service, to reduce impact on the service of the secondary card. The measurement proportion is a ratio of measurement duration corresponding to the first service to a measurement cycle corresponding to the first service. A smaller measurement proportion (for example, a longer measurement cycle or measurement gap) indicates smaller impact on the service of the secondary card.

It should be noted that values of the measurement cycle (namely, a minimum measurement gap) and the measurement duration may be specifically preset based on an actual use requirement. This is not limited in this embodiment of this application. For example, the measurement cycle may be set to be greater than the measurement cycle set in the related technology, and/or the measurement duration may be set to be less than the measurement duration set in the related technology. For example, in the service processes of the two cards, if a measurement antenna of the primary card conflicts with an antenna of the secondary card, the measurement cycle is prolonged. For example, a minimum measurement cycle is controlled to be 80 milliseconds (ms), and the uplink/downlink service of the secondary card is suppressed in the measurement process. Increasing the measurement cycle can significantly reduce the impact of the measurement by the primary card on the service of the secondary card service.

It is assumed that an available antenna of the frequency band corresponding to the inter-frequency inter-RAT measurement service of the primary card is the primary and diversity antenna. When a conflict occurs when the measurement frequency band of the primary card and the frequency band of the service of the secondary card share the two antennas, a gap between two times of measurement by the primary card may be increased, and a gap between two times of measurement of a same type of frequency band is controlled to be 80 ms, to reduce impact of measurement by the primary card on the service of the secondary card. In the conventional technology, a measurement cycle of a primary card is usually set to 40 ms, and measurement duration is 6 ms. In a case in which all antennas conflict, assuming that a processing priority of a measurement service of the primary card is higher than a processing priority of an uplink/downlink service of a secondary card, the service of the secondary card needs to be suppressed during inter-frequency inter-RAT measurement by the primary card. Each measurement service of the primary card causes interruption of the uplink/downlink service of the secondary card for at least 6 ms, and a corresponding impact ratio is relatively large, which causes a decrease in a data transmission rate of the secondary card and deterioration in voice quality. Compared with the conventional technology, in this application, because a cycle of measuring a conflicting frequency is increased, impact of measurement performed by the primary card on the service of the secondary card can be reduced.

In addition, compared with the conventional technology, in this embodiment of this application, impact of inter-frequency inter-RAT measurement by the primary card on the service of the secondary card in most scenarios can be avoided. For example, for a currently common terminal specification, an MHB of sub-3G supports four antennas (4R), and the MHB of sub-3G and an LB of sub-3G can perform services in parallel, without a conflict. Therefore, by using the solution provided in this application, a scenario in which an uplink/downlink service of the secondary card needs to be suppressed in a measurement process of the primary card is effectively reduced. Currently, the following scenario is mainly considered: The uplink/downlink service of the secondary card is suppressed during measurement by the primary card when the primary card is of the LB and the secondary card is of the LB. For example, based on statistics on a proportion of each frequency band in a live network, as shown in the following Table 4, the B8 frequency band and the B34 frequency band belong to the LB, other frequency bands belong to the MHB, and a proportion of the secondary card working in the LB is about 5%. When both the service of the primary card and the service of the secondary card work in the B8 or B34 frequency band, the service of the secondary card is suppressed. By applying the solution provided in this application, duration of suppressing the uplink/downlink service of the secondary card in a measurement service process of the primary card is effectively reduced, and a corresponding impact proportion is relatively small.

TABLE 4

| Frequency band | Proportion |
|---|---|
| B3 | 8.2% |
| B8 | 5.5% |
| B34 | 2% |
| B38 | 28.7% |
| B39 | 31.2% |
| B40 | 21.6% |
| B41 | 3.8% |

In conclusion, in this embodiment of this application, the terminal device may determine, based on the target frequency of inter-frequency inter-RAT measurement by the primary card and the working frequency of the uplink/downlink service of the secondary card, a front-end antenna conflict status, and in a case of a conflict, dynamically select an antenna that does not conflict with the service of the secondary card for the primary card to receive a signal. Alternatively, when there is an antenna conflict between the target frequency measured by the primary card and the service frequency of the secondary card, measurement duration may be reduced or a measurement cycle may be increased, to reduce impact of measurement by the primary card on the service of the secondary card. Alternatively, in a scenario in which the measurement service of the primary card and the uplink/downlink service of the secondary card can coexist, the secondary card service does not need to be suppressed, and parallel processing of the two services is maintained.

It should be noted that in this embodiment of this application, “greater than” may be replaced with “greater than or equal to”, “less than or equal to” may be replaced with “less than”, or “greater than or equal to” may be replaced with “greater than”, and “less than” may be replaced with “less than or equal to”.

Embodiments described in this specification may be independent solutions, or may be combined based on internal logic. These solutions all fall within the protection scope of this application.

It may be understood that in the foregoing method embodiments, the methods and operations implemented by the network device may alternatively be implemented by a component (such as a chip or a circuit) that can be used in the network device. In the foregoing method embodiments, the methods and operations implemented by the terminal device may alternatively be implemented by a component (such as a chip or a circuit) that can be used in the terminal device. In the foregoing method embodiments, the methods and operations implemented by the core network device may alternatively be implemented by a component (such as a chip or a circuit) that can be used in the core network device.

The foregoing describes method embodiments provided in this application, and the following describes apparatus embodiments provided in this application. It should be understood that descriptions of apparatus embodiments correspond to the descriptions of method embodiments. Therefore, for content that is not described in detail, refer to the foregoing method embodiments. For brevity, details are not described herein again.

The foregoing mainly describes the solutions provided in embodiments of this application from the perspective of interaction between devices. It may be understood that, to implement the foregoing functions, each device, such as a transmitting end device or a receiving end device, includes a corresponding hardware structure and/or software module for performing each function. A person skilled in the art should be able to be aware that, in combination with the examples described in embodiments disclosed in this specification, units and algorithm steps can be implemented by hardware or a combination of hardware and computer hardware in this application. Whether a function is performed by hardware or hardware driven by computer software depends on particular applications and design constraints of the technical solutions. A person skilled in the art may use different methods to implement the described functions for each particular application, but it should not be considered that the implementation goes beyond the protection scope of this application.

In embodiments of this application, the transmitting end device or the receiving end device may be divided into functional modules based on the foregoing method examples. For example, the transmitting end device or the receiving end device may be divided into functional modules based on corresponding functions, or two or more functions may be integrated into one processing module. The integrated module may be implemented in a form of hardware, or may be implemented in a form of a software functional module. It should be noted that, in embodiments of this application, division into the modules is an example, and is merely logical function division. During actual implementation, another division manner may be used. An example in which each functional module is obtained through division based on each corresponding function is used below for description.

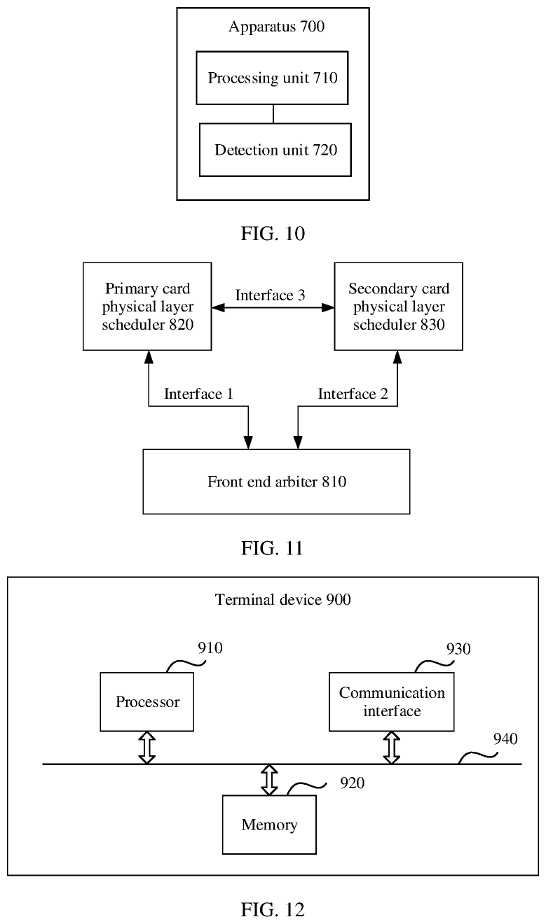

FIG. 10 is a schematic block diagram of a service processing apparatus 700 according to an embodiment of this application. The apparatus 700 may be configured to perform an action performed by the terminal device in the foregoing method embodiments. The apparatus 700 includes a processing unit 710 and a detection unit 720.

The processing unit 710 is configured to: when the apparatus 700 carries a first subscriber identity module SIM card and a second SIM card, control the second SIM card to process an uplink/downlink transmission service by using N antennas, where the N antennas are one or more antennas of M antennas supported by the apparatus 700.

The processing unit 710 is further configured to: when the detection unit 720 detects that the apparatus 700 meets a preset condition, control the first SIM card to process a neighboring cell measurement service by using at least one antenna of M-N antennas, where an operating band of the neighboring cell measurement service is the same as an operating band of the uplink/downlink transmission service.

In an optional embodiment, the preset condition may include at least one of the following conditions: signal quality of a serving cell of the first SIM card is lower than a preset signal quality threshold; and the apparatus 700 receives a measurement configuration message delivered by a network device, where the measurement configuration message indicates to measure signal quality of a neighboring cell of the serving cell.

In an optional embodiment, the processing unit 710 is further configured to: when the second SIM card is in a standby state and the apparatus 700 meets the preset condition, control the first SIM card to process the neighboring cell measurement service by using the N antennas.

In an optional embodiment, the processing unit 710 is specifically configured to: when the first SIM card is in a standby state and the second SIM card is in a connected state, control the second SIM card to process the uplink/downlink transmission service by using the N antennas; or when the first SIM card is in a connected state and the second SIM card is in a connected state, control the second SIM card to process the uplink/downlink transmission service by using the N antennas.

In an optional embodiment, the processing unit 710 is further configured to: determine, based on the operating band of the neighboring cell measurement service and the operating band of the uplink/downlink transmission service, that the antenna used by the first SIM card to process the neighboring cell measurement service is at least one antenna of the M-N antennas.

In an optional embodiment, the M antennas may include a primary and diversity antenna and a MIMO primary and diversity antenna, the primary and diversity antenna includes a primary antenna and a diversity antenna, and the MIMO primary and diversity antenna includes a MIMO primary antenna and a MIMO diversity antenna.

In an optional embodiment, when M is 4 and N is 1, the processing unit 710 is specifically configured to: when the second SIM card uses the primary antenna, control the first SIM card to receive a signal of the neighboring cell measurement service by using the MIMO primary and diversity antenna; or when the second SIM card uses the diversity antenna, control the first SIM card to receive a signal of the neighboring cell measurement service by using the MIMO primary and diversity antenna; or when the second SIM card uses the MIMO primary antenna, control the first SIM card to receive a signal of the neighboring cell measurement service by using the primary and diversity antenna; or when the second SIM card uses the MIMO diversity antenna, control the first SIM card to receive a signal of the neighboring cell measurement service by using the primary and diversity antenna.

In an optional embodiment, when M is 4 and N is 2, the processing unit 710 is specifically configured to: when the second SIM card uses the primary and diversity antenna, control the first SIM card to receive a signal of the neighboring cell measurement service by using the MIMO primary and diversity antenna; or when the second SIM card uses the MIMO primary and diversity antenna, control the first SIM card to receive a signal of the neighboring cell measurement service by using the primary and diversity antenna; or when the second SIM card uses the primary antenna and the MIMO primary antenna, control the first SIM card to receive a signal of the neighboring cell measurement service by using the diversity antenna and the MIMO diversity antenna; or when the second SIM card uses the primary antenna and the MIMO diversity antenna, control the first SIM card to receive a signal of the neighboring cell measurement service by using the diversity antenna and the MIMO primary antenna; or when the second SIM card uses the diversity antenna and the MIMO primary antenna, control the first SIM card to receive a signal of the neighboring cell measurement service by using the primary antenna and the MIMO diversity antenna; or when the second SIM card uses the diversity antenna and the MIMO diversity antenna, control the first SIM card to receive a signal of the neighboring cell measurement service by using the primary antenna and the MIMO primary antenna.

In an optional embodiment, when M is 4 and N is 3, the processing unit 710 is specifically configured to: when the second SIM card uses the primary and diversity antenna and the MIMO primary antenna, control the first SIM card to receive a signal of the neighboring cell measurement service by using the MIMO diversity antenna; or when the second SIM card uses the primary and diversity antenna and the MIMO diversity antenna, control the first SIM card to receive a signal of the neighboring cell measurement service by using the MIMO primary antenna; or when the second SIM card uses the primary antenna and the MIMO primary and diversity antenna, control the first SIM card to receive a signal of the neighboring cell measurement service by using the primary antenna; or when the second SIM card uses the diversity antenna and the MIMO primary and diversity antenna, control the first SIM card to receive a signal of the neighboring cell measurement service by using the primary antenna.

In an optional embodiment, the processing unit 710 is further configured to: if the second SIM card processes the uplink/downlink transmission service by using the N antennas, when the detection unit 720 detects that the apparatus 700 meets the preset condition, control the first SIM card to process the neighboring cell measurement service by using the N antennas, where the operating band of the neighboring cell measurement service is different from the operating band of the uplink/downlink transmission service.

In an optional embodiment, the processing unit 710 is further configured to: if the second SIM card process the uplink/downlink transmission service by using the M antennas, when the detection unit 720 detects that the apparatus 700 meets the preset condition, control the first SIM card and the second SIM card to process services by using the M antennas in a time-division manner, where the operating band of the neighboring cell measurement service of the first SIM card is the same as the operating band of the uplink/downlink transmission service of the second SIM card.

A measurement proportion corresponding to the neighboring cell measurement service is less than a preset threshold, and the measurement proportion is a ratio of measurement duration corresponding to the neighboring cell measurement service to a measurement cycle corresponding to the neighboring cell measurement service.

In an optional embodiment, the first SIM card may be a primary card, and the second SIM card may be a secondary card.

For example, as shown in FIG. 11, the processing unit 710 may be specifically a front-end arbiter 810. The front-end arbiter 810 is interconnected with a physical layer scheduler 820 of the primary card through an interface 1, and is interconnected with a physical layer scheduler 830 of the secondary card through an interface 2, where the physical layer scheduler 820 of the primary card is interconnected with the physical layer scheduler 830 of the secondary card through an interface 3. The front-end arbiter 810 is responsible for performing arbitration judgment on a conflict status of operating band combinations of the two cards. The physical layer scheduler 820 of the primary card is responsible for scheduling an uplink/downlink service of the primary card, the inter-frequency inter-RAT measurement service, and the like. The physical layer scheduler 830 of the secondary card is responsible for scheduling the uplink/downlink transmission service of the secondary card.

The apparatus 700 in this embodiment of this application may correspondingly perform the method described in embodiments of this application. In addition, the foregoing and other operations and/or functions of the units in the apparatus 700 are separately used to implement corresponding procedures of the method. For brevity, details are not described herein again.

According to the service processing apparatus provided in this embodiment of this application, when the terminal device carries a primary card and a secondary card, the secondary card processes an uplink/downlink transmission service by using N antennas by default. When the primary card is triggered to perform neighboring cell measurement (namely, inter-frequency inter-RAT measurement), and a measurement frequency band is the same as an operating band of the secondary card, the primary card may select antennas different from N antennas used by the secondary card to perform neighboring cell measurement. Because signal crosstalk occurs in signals with a same frequency band in an antenna receive channel, when the measurement frequency band of the primary card is the same as the operating band of the secondary card, it can be determined that a conflict occurs if the primary card and the secondary card share an antenna. Therefore, the primary card may perform neighboring cell measurement by using an antenna different from an antenna occupied by the secondary card, so as to ensure that the two cards can process services in parallel and do not affect each other, thereby resolving a current problem that signal crosstalk is caused when two cards in the terminal device share an antenna to process services in parallel.

FIG. 12 is a schematic diagram of a structure of a terminal device 900 according to an embodiment of this application. The terminal device 900 includes a processor 910, a memory 920, a communication interface 930, and a bus 940.

In a possible implementation, the processor 910 in the terminal device 900 shown in FIG. 12 may correspond to the processing unit 710 in the apparatus 700 in FIG. 10. The communication interface 930 in the terminal device 900 shown in FIG. 12 may correspond to the detection unit 720 in the apparatus 700 in FIG. 10.

The processor 910 may be connected to the memory 920. The memory 920 may be configured to store program code and data. Therefore, the memory 920 may be a storage unit in the processor 910, an external storage unit independent of the processor 910, or a component including the storage unit in the processor 910 and the external storage unit independent of the processor 910.

Optionally, the terminal device 900 may further include a bus 940. The memory 920 and the communication interface 930 may be connected to the processor 910 by using the bus 940. The bus 940 may be a peripheral component interconnect (peripheral component interconnect, PCI) bus, an extended industry standard architecture (extended industry standard architecture, EISA) bus, or the like. The bus 940 may be categorized as an address bus, a data bus, a control bus, or the like. For ease of indication, the bus is indicated by using only one line in FIG. 12. However, it does not indicate that there is only one bus or only one type of bus.

It should be understood that in this embodiment of this application, the processor 910 may be a central processing unit (central processing unit, CPU). The processor may alternatively be another general-purpose processor, a digital signal processor (digital signal processor, DSP), an application-specific integrated circuit (application-specific integrated circuit, ASIC), a field programmable gate array (field programmable gate array, FPGA), or another programmable logic device, for example, a discrete gate, a transistor logic device, a discrete hardware component, or the like. The general-purpose processor may be a microprocessor, or the processor may be any conventional processor, or the like. Alternatively, the processor 810 is configured to execute a related program by using one or more integrated circuits, to implement technical solutions provided in embodiments of this application.

The memory 920 may include a read-only memory and a random access memory, and provides an instruction and data to the processor 910. A part of the processor 910 may further include a nonvolatile random access memory. For example, the processor 910 may further store device type information.

When the terminal device 900 runs, the processor 910 executes computer executable instructions in the memory 920, to perform the operation steps of the foregoing method by using the apparatus 700.

It should be understood that, the terminal device 900 in this embodiment of this application may correspond to the apparatus 700 in the embodiment of this application. In addition, the foregoing and other operations and/or functions of the units in the apparatus 700 are separately used to implement corresponding procedures of the method. For brevity, details are not described herein again.

Optionally, in some embodiments, an embodiment of this application further provides a computer-readable medium. The computer-readable medium stores program code. When the computer program code is run on a computer, the computer is enabled to perform the method in the foregoing aspects.

Optionally, in some embodiments, an embodiment of this application further provides a chip, including a processor. The processor is configured to read and execute a computer program stored in a memory, to perform the method in the foregoing aspects.

Optionally, in some embodiments, an embodiment of this application further provides a computer program product. The computer program product includes computer program code. When the computer program code is run on a computer, the computer is enabled to perform the method in the foregoing aspects.

In embodiments of this application, the terminal device or the network device includes a hardware layer, an operating system layer running on the hardware layer, and an application layer running on the operating system layer. The hardware layer may include hardware such as a central processing unit (central processing unit, CPU), a memory management unit (memory management unit, MMU), and a memory (which is also referred to as a main memory). An operating system at the operating system layer may be any one or more computer operating systems that implement service processing through a process (process), for example, a Linux operating system, a Unix operating system, an Android operating system, an iOS operating system, or a Windows operating system. The application layer may include applications such as a browser, an address book, word processing software, and instant communication software.

A specific structure of an execution body of the method provided in embodiments of this application is not specifically limited in embodiments of this application, provided that a program that records code of the method provided in embodiments of this application can be run to perform communication according to the method provided in embodiments of this application. For example, the method provided in this embodiment of this application may be performed by a terminal device, or a function module that can invoke and execute a program in the terminal device.

Aspects or features of this application may be implemented as a method, an apparatus, or a product that uses standard programming and/or engineering technologies. The term “product” used in this specification may cover a computer program that can be accessed from any computer-readable component, carrier or medium. For example, the computer-readable medium may include but is not limited to a magnetic storage component (for example, a hard disk drive, a floppy disk, a magnetic tape, or the like), an optical disc (for example, a compact disc (compact disc, CD), a digital versatile disc (digital versatile disc, DVD), or the like), a smart card, and a flash memory component (for example, an erasable programmable read-only memory (erasable programmable read-only memory, EPROM), a card, a stick, a key drive, or the like).

Various storage media described in this specification may indicate one or more devices and/or other machine-readable media that are configured to store information. The term “machine-readable media” may include but is not limited to a radio channel and various other media that can store, include, and/or carry instructions and/or data.

It should be understood that the processor in embodiments of this application may be a central processing unit (central processing unit, CPU), or may be another general-purpose processor, a digital signal processor (digital signal processor, DSP), an application-specific integrated circuit (application-specific integrated circuit, ASIC), a field programmable gate array (field programmable gate array, FPGA) or another programmable logic device, a discrete gate or transistor logic device, a discrete hardware component, or the like. The general-purpose processor may be a microprocessor, or the processor may be any conventional processor, or the like.

It may be understood that the memory mentioned in embodiments of this application may be a volatile memory or a nonvolatile memory, or may include a volatile memory and a nonvolatile memory. The nonvolatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random access memory (random access memory, RAM). For example, the RAM may be used as an external cache. By way of example and not limitation, the RAM may include the following plurality of forms: a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus dynamic random access memory (direct rambus RAM, DR RAM).

It should be noted that when the processor is a general-purpose processor, a DSP, an ASIC, an FPGA or another programmable logic device, a discrete gate or a transistor logic device, or a discrete hardware component, the memory (storage module) may be integrated into the processor.

It should further be noted that the memory described in this specification aims to include but is not limited to these memories and any memory of another proper type.

A person of ordinary skill in the art may be aware that, in combination with the examples described in embodiments disclosed in this specification, units and methods may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the protection scope of this application.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, may be located in one position, or may be distributed on a plurality of network units. Some or all of the units may be selected based on actual requirements to achieve the objectives of the solutions of embodiments.

In addition, function units in embodiments of this application may be integrated into one unit, each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of embodiments of this application essentially, or the part contributing to the conventional technology, or some of the technical solutions may be implemented in the form of a computer software product. The computer software product is stored in a storage medium, and the computer software product includes several instructions for enabling a computer device (which may be a personal computer, a server, or a network device) to perform all or some of the steps of the method described in embodiments of this application. The foregoing storage medium may include but is not limited to any medium that can store program code, such as a USB flash drive, a removable hard disk, a read-only memory (read-only memory, ROM), a random access memory (random access memory, RAM), a magnetic disk, or an optical disc.

Unless otherwise defined, all technical and scientific terms used in this specification have same meanings as those usually understood by a person skilled in the art of this application. The terms used in the specification of this application are merely for the purpose of describing specific embodiments, and are not intended to limit this application.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1.-24. (canceled)

25. A method, comprising:
when a terminal device carries a first subscriber identity module (SIM) card and a second SIM card, processing, by the second SIM card, an uplink/downlink transmission service through N antennas, wherein the terminal device comprises M antennas, and the N antennas are one or more antennas of the M antennas; and
when the terminal device meets a preset condition, processing, by the first SIM card, a neighboring cell measurement service through at least one antenna of the M antennas that is not of the N antennas, wherein an operating band of the neighboring cell measurement service is the same as an operating band of the uplink/downlink transmission service.

26. The method according to claim 25, wherein the preset condition comprises:
signal quality of a serving cell of the first SIM card is lower than a preset signal quality threshold; or
the terminal device receives a measurement configuration message delivered by a network device, wherein the measurement configuration message indicates to measure signal quality of a neighboring cell of the serving cell.

27. The method according to claim 25, wherein the method further comprises:
when the second SIM card is in a standby state and the terminal device meets the preset condition, processing, by the first SIM card, the neighboring cell measurement service through the N antennas.

28. The method according to claim 25, wherein processing, by the second SIM card, an uplink/downlink transmission service through N antennas comprises:
when the first SIM card is in a standby state and the second SIM card is in a connected state, processing, by the second SIM card, the uplink/downlink transmission service through the N antennas; or
when the first SIM card is in a connected state and the second SIM card is in a connected state, processing, by the second SIM card, the uplink/downlink transmission service through the N antennas.

29. The method according to claim 25, wherein before processing, by the first SIM card, the neighboring cell measurement service through the at least one antenna of the M antennas that is not of the N antennas, the method further comprises:
determining, based on the operating band of the neighboring cell measurement service and the operating band of the uplink/downlink transmission service, that an antenna through which the first SIM card processes the neighboring cell measurement service is the at least one antenna of the M antennas that is not of the N antennas.

30. The method according to claim 25, wherein the M antennas comprise a primary and diversity antenna and a multiple-input multiple-output MIMO primary and diversity antenna, the primary and diversity antenna comprises a primary antenna and a diversity antenna, and the MIMO primary and diversity antenna comprises a MIMO primary antenna and a MIMO diversity antenna.

31. The method according to claim 30, wherein when M is 4 and N is 1, processing, by the first SIM card, the neighboring cell measurement service through the at least one antenna of the M antennas that is not of the N antennas comprises:
when the second SIM card uses the primary antenna, receiving, by the first SIM card, a signal of the neighboring cell measurement service through the MIMO primary and diversity antenna;
when the second SIM card uses the diversity antenna, receiving, by the first SIM card, a signal of the neighboring cell measurement service through the MIMO primary and diversity antenna;
when the second SIM card uses the MIMO primary antenna, receiving, by the first SIM card, a signal of the neighboring cell measurement service through the primary and diversity antenna; or
when the second SIM card uses the MIMO diversity antenna, receiving, by the first SIM card, a signal of the neighboring cell measurement service through the primary and diversity antenna.

32. The method according to claim 30, wherein when M is 4 and N is 2, processing, by the first SIM card, the neighboring cell measurement service through the at least one antenna of the M antennas that is not of the N antennas comprises:
when the second SIM card uses the primary and diversity antenna, receiving, by the first SIM card, a signal of the neighboring cell measurement service through the MIMO primary and diversity antenna;
when the second SIM card uses the MIMO primary and diversity antenna, receiving, by the first SIM card, a signal of the neighboring cell measurement service through the primary and diversity antenna;
when the second SIM card uses the primary antenna and the MIMO primary antenna, receiving, by the first SIM card, a signal of the neighboring cell measurement service through the diversity antenna and the MIMO diversity antenna;
when the second SIM card uses the primary antenna and the MIMO diversity antenna, receiving, by the first SIM card, a signal of the neighboring cell measurement service through the diversity antenna and the MIMO primary antenna;
when the second SIM card uses the diversity antenna and the MIMO primary antenna, receiving, by the first SIM card, a signal of the neighboring cell measurement service through the primary antenna and the MIMO diversity antenna; or
when the second SIM card uses the diversity antenna and the MIMO diversity antenna, receiving, by the first SIM card, a signal of the neighboring cell measurement service through the primary antenna and the MIMO primary antenna.

33. The method according to claim 30, wherein when M is 4 and N is 3, processing, by the first SIM card, the neighboring cell measurement service through the at least one antenna of the M antennas that is not of the N antennas comprises:
when the second SIM card uses the primary and diversity antenna and the MIMO primary antenna, receiving, by the first SIM card, a signal of the neighboring cell measurement service through the MIMO diversity antenna;
when the second SIM card uses the primary and diversity antenna and the MIMO diversity antenna, receiving, by the first SIM card, a signal of the neighboring cell measurement service through the MIMO primary antenna;
when the second SIM card uses the primary antenna and the MIMO primary and diversity antenna, receiving, by the first SIM card, a signal of the neighboring cell measurement service through the diversity antenna; or
when the second SIM card uses the diversity antenna and the MIMO primary and diversity antenna, receiving, by the first SIM card, a signal of the neighboring cell measurement service through the primary antenna.

34. The method according to claim 25, wherein the method further comprises:
when the second SIM card processes the uplink/downlink transmission service through the N antennas, when the terminal device meets the preset condition, processing, by the first SIM card, the neighboring cell measurement service through the N antennas, wherein the operating band of the neighboring cell measurement service is different from the operating band of the uplink/downlink transmission service.

35. The method according to claim 25, wherein the method further comprises:
when the second SIM card processes the uplink/downlink transmission service through the M antennas, when the terminal device meets the preset condition, processing, by the first SIM card and the second SIM card, services through the M antennas in a time-division manner, wherein the operating band of the neighboring cell measurement service is the same as the operating band of the uplink/downlink transmission service, wherein a measurement proportion corresponding to the neighboring cell measurement service is less than a preset threshold, and the measurement proportion is a ratio of measurement duration corresponding to the neighboring cell measurement service to a measurement cycle corresponding to the neighboring cell measurement service.

36. The method according to claim 25, wherein the first SIM card is a primary card, and the second SIM card is a secondary card.

37. An apparatus, comprising:
M antennas;
at least one processor;
a non-transitory memory coupled to the at least one processor and configured to store programming instructions that, when executed by the at least one processor, cause apparatus to:
when the apparatus carries a first subscriber identity module (SIM) card and a second SIM card, control the second SIM card to process an uplink/downlink transmission service through N antennas, wherein the N antennas are one or more antennas of the M antennas; and
when detecting that the apparatus meets a preset condition, control the first SIM card to process a neighboring cell measurement service through at least one antenna of the M antennas that is not of the N antennas, wherein an operating band of the neighboring cell measurement service is the same as an operating band of the uplink/downlink transmission service.

38. The apparatus according to claim 37, wherein the preset condition comprises:
signal quality of a serving cell of the first SIM card is lower than a preset signal quality threshold; or
the apparatus receives a measurement configuration message delivered by a network device, wherein the measurement configuration message indicates to measure signal quality of a neighboring cell of the serving cell.

39. The apparatus according to claim 37, wherein the programming instructions that, when executed by the at least one processor, further cause the apparatus to:
when the second SIM card is in a standby state and the apparatus meets the preset condition, control the first SIM card to process the neighboring cell measurement service through the N antennas.

40. The apparatus according to claim 37, wherein the programming instructions that, when executed by the at least one processor, further cause the apparatus to:
when the first SIM card is in a standby state and the second SIM card is in a connected state, control the second SIM card to process the uplink/downlink transmission service through the N antennas; or
when the first SIM card is in a connected state and the second SIM card is in a connected state, control the second SIM card to process the uplink/downlink transmission service through the N antennas.

41. The apparatus according to claim 37, wherein the programming instructions that, when executed by the at least one processor, further cause the apparatus to:
determine, based on the operating band of the neighboring cell measurement service and the operating band of the uplink/downlink transmission service, that an antenna through which the first SIM card processes the neighboring cell measurement service is the at least one antenna of the M antennas that is not of the N antennas.

42. The apparatus according to claim 37, wherein the M antennas comprise a primary and diversity antenna and a multiple-input multiple-output MIMO primary and diversity antenna, the primary and diversity antenna comprises a primary antenna and a diversity antenna, and the MIMO primary and diversity antenna comprises a MIMO primary antenna and a MIMO diversity antenna.

43. The apparatus according to claim 37, wherein the programming instructions that, when executed by the at least one processor, further cause the apparatus to:
when the second SIM card processes the uplink/downlink transmission service through the N antennas and when the apparatus meets the preset condition, control the first SIM card to process the neighboring cell measurement service through the N antennas, wherein the operating band of the neighboring cell measurement service is different from the operating band of the uplink/downlink transmission service.

44. The apparatus according to claim 37, wherein the programming instructions that, when executed by the at least one processor, further cause the apparatus to:
when the second SIM card processes the uplink/downlink transmission service through the M antennas and the apparatus meets the preset condition, control the first SIM card and the second SIM card to process services through the M antennas in a time-division manner, wherein the operating band of the neighboring cell measurement service is the same as the operating band of the uplink/downlink transmission service, wherein a measurement proportion corresponding to the neighboring cell measurement service is less than a preset threshold, and the measurement proportion is a ratio of measurement duration corresponding to the neighboring cell measurement service to a measurement cycle corresponding to the neighboring cell measurement service.
